(19) United States
(12) Patent Application Publication
(10) Pub. No.: US 2024/0092950 A1
(43) Pub. Date: Mar. 21, 2024

(54) METHOD OF PERFORMING LIVING CATIONIC POLYMERIZATION OF MONOMERS BY SUPERMOLECULAR ANION-BINDING CATALYSIS

(71) Applicant: Changchun Institute of Applied Chemistry Chinese Academy of Sciences, Changchun City (CN)

(72) Inventors: Youhua Tao, Changchun City (CN); Maosheng Li, Changchun City (CN)

(21) Appl. No.: 18/452,443

(22) Filed: Aug. 18, 2023

(30) Foreign Application Priority Data
Aug. 25, 2022 (CN) 202211024534.9

(51) Int. Cl. C08F 116/20; C08F 4/00; C08F 116/34; C08F 126/12

(52) U.S. Cl. CPC C08F 116/20; C08F 4/00; C08F 116/34; C08F 126/12; C08F 2438/00

(57) ABSTRACT

The present application relates to a method of performing living cationic polymerization of monomers by supermolecular anion-binding catalysis. It uses various simple Bronsted acids or adducts thereof with a monomer as the cationic initiator, and various hydrogen bond donors as the catalyst for binding and dissociating counter anions dynamically, to living and controlled polymerize one or more cationically polymerizable monomers to form a homopolymer or a copolymer. In the present application, the hydrogen-bond donor can exert non-covalent anion-binding interactions to dynamically and reversibly activate dormant covalent bond under mild conditions, in turn to precisely control the equilibrium between dormant covalent precursors and active cationic species, thereby achieving the precise control of the polymer's molecular weight, distribution and end group structure, and solving the environment-unfriendly relevant problems in traditional metal-based Lewis acid catalysis, which include extreme low polymerization temperature, restrict anhydrous requirement of the reaction, strict purification requirement of the monomer and catalysis-initiating system, metal residue in polymer or the like.

### CROSS-REFERENCE TO RELATED APPLICATIONS

This application claims priority to Chinese Patent Application No. 202211024534.9, filed on Aug. 25, 2022, the content of which is incorporated herein by reference in its entirety.

### TECHNICAL FIELD

The present application belongs to the technical field of catalysis in polymerization, in particular, to a method of performing living cationic polymerization of monomers by supermolecular anion-binding catalysis.

### BACKGROUND

Cationic polymerization is one of the most important methods for synthesis of macromolecules, involves a wide range of polymerizable monomers, such as vinyl ethers, isobutylene, styrene derivatives, aldehydes, cyclic acetals, and cyclic ethers (Prog. Polym. Sci. 16, 111-172 (1991); Polym. Int 35, 1-26 (1994); Chem. Rev. 109, 5245-5287 (2009)). Cationic polymerization usually has advantages, such as faster reaction kinetics, no oxygen inhibition phenomenon and low pre-post polymerization volume shrinkage ratio, and has received great attention in the field of industrial applications. Representative industrial products include polyvinyl ether, polyisobutylene and butyl rubbers. However, due to the inherent high activity and instability of cationic active species, various side reactions, such as β-hydrogen elimination, intramolecular rearrangement isomerization, chain transfer to monomer or solvent and chain termination or the like, are prone to occur in the polymerization process (Prog. Polym. Sci. 16, 111-172 (1991); Polym. Int 35, 1-26 (1994); Chem. Rev. 109, 5245-5287 (2009)). These side reactions seem to be difficult to overcome, so that after the living polymerization was first reported (1950s) in anionic polymerization, people deemed that living cationic polymerization was impossible to be realized for quite a long period of time.

Until 1984, Higashimura and Sawamoto et al. proposed that in the cationic polymerization process, a lower concentration of cationic active species is maintained by activating dormant covalent bonds reversibly, thereby suppressing unfavorable chain transfer and chain termination side reactions, and realizing living cationic polymerization (Macromolecules 17, 265-268, (1984)). Currently, this reversible activation mechanism mainly relies on metal-based Lewis acids to mediate a reversible and transient activation of dormant covalent bonds (C—X, X═Cl, AcO, etc.) into cationic active species (Chem. Rev. 109, 5245-5287 (2009)). However, metal-based Lewis acid center having a high electron deficiency has a higher binding energy with the counter anion, and the dormant covalent bond is easy to be activated to generate a higher concentration of cationic species. In order to realize living and controlled polymerization results, the polymerization reaction catalyzed by metal-based Lewis acid usually needs to be carried out at an extremely low temperature (−78° C. to −100° C.), the reaction system needs to be strictly anhydrous, and the reaction reagents need to be strictly purified. In addition, metal residues are unavoidable in the final polymer (Chem. Rev. 109, 5245-5287 (2009)). In fact, in terms of meeting the requirements of advanced materials engineering, the metal contamination and the harsh reaction conditions have become long-term challenges limiting the further development of living cationic polymerization.

As a result, there is a strong need for a novel metal-free catalysis method for living cationic polymerization that allows for precise control of the polymer's molecular weight, distribution, and end group structure while avoiding harsh polymerization reaction conditions.

### SUMMARY

The present application seeks to solve the technical problem in the related art, and provides a method of performing living cationic polymerization of monomers by supermolecular anion-binding catalysis. This method is a new method, in which catalysts can activate the dormant covalent bonds dynamically and reversibly based on the supermolecular anion-binding interaction, and further control precisely the equilibrium and conversion between the dormant covalent precursor and the cationic active species, thereby enabling living cationic polymerization of electron-rich ethylenic monomers and other cationically polymerizable monomers under mild conditions. In order to solve the above-mentioned technical problem, the specific technical solutions of the present application are as follows.

The present application provides a method of performing living cationic polymerization of monomers by supermolecular anion-binding catalysis, comprising the following steps of:
in the presence of a cationic initiator and a hydrogen-bond donor, polymerizing one or more electron-rich ethylenic monomers or other monomers capable of being polymerized by cationic polymerization with a controllable activity to form a homopolymer or a copolymer;
the cationic initiator is an initiator capable of generating a cationic active species by an effect of the hydrogen-bond donor;
the hydrogen-bond donor is a hydrogen-bond donor capable of extracting and binding a counter anion from the cationic initiator or a chain end of a dormant polymer to generate the cationic active species by a supermolecular anion-binding interaction, to realize instant reversible conversion between a dormant species and the cationic active species, and to facilitate a polymerization reaction between the cationic active species and a monomer capable of being polymerized by cationic polymerization.

In the technical solution above, preferably, the cationic initiator is a Bronsted acid or an adduct;
the Bronsted acid has a general structural formula of H—X;
wherein X is selected from Cl, Br, I, ClO₄, BrO₄, IO₄, CN, N₃, (C₆F₅)₄B, SCN, NO₂, PF₆, BF₄, SbF₆, R¹⁹COO, R²⁰SO₃, OP(═O)(OR²¹)₂, SC(═S)NR²², OR²³, SR²⁴ or N(SO₂R²⁵)₂;
R¹⁹, R²⁰, R²¹, R²², R²³, R²⁴ and R²⁵ are independently selected from hydrogen, a halogen atom, CN, SCN, NO₂, C₆F₅, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group or a C₅₋₃₀ heteroaryl group;
the adduct is one or more selected from the following general structural formulas:

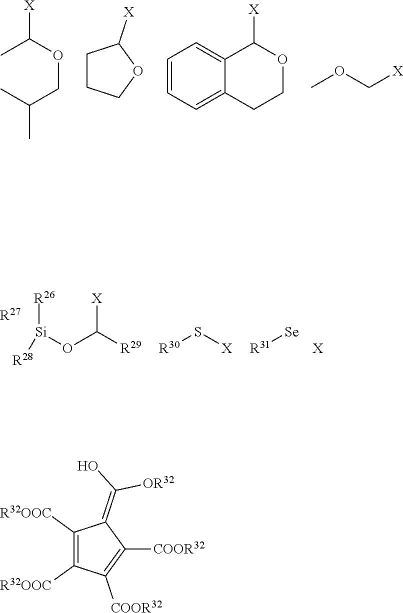

wherein X has a definition as above, R²⁶, R²⁷, R²⁸, R²⁹, R³⁰, R³¹ and R³² are independently selected from hydrogen, a C₁₋₃₀ alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, or a C₅₋₃₀ heteroaryl group.

In the technical solution above, more preferably, the Bronsted acid is one selected from the following structures:

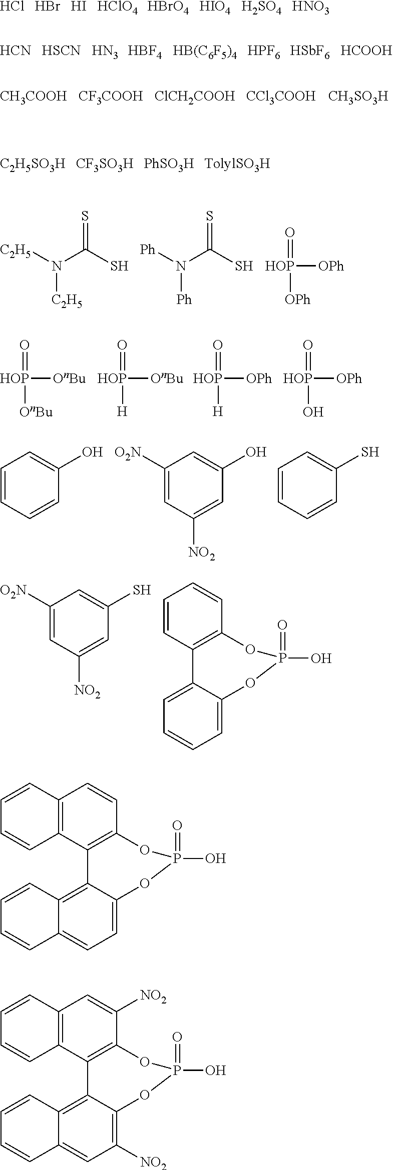

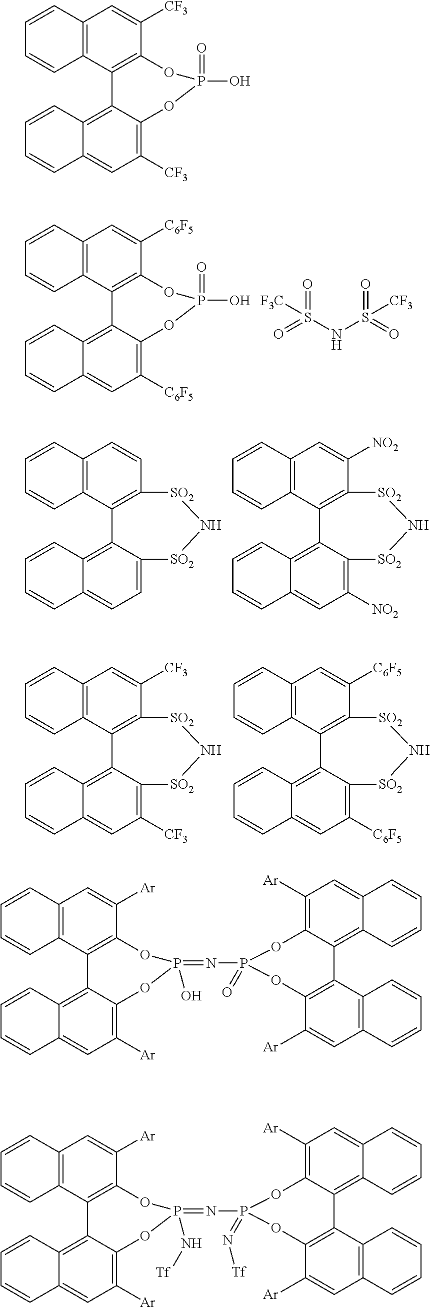

wherein Ph represents phenyl; ⁿu represents n-butyl; tolyl represents tolyl; Ar represents aryl; Tf represents trifluoromethanesulfonyl;
the adduct is one or more selected from the following structures:

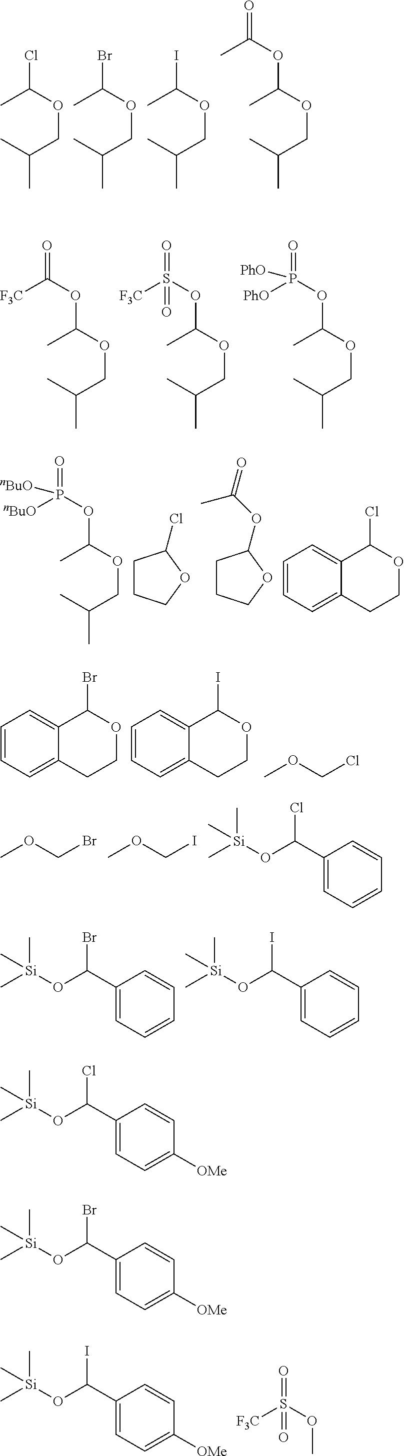

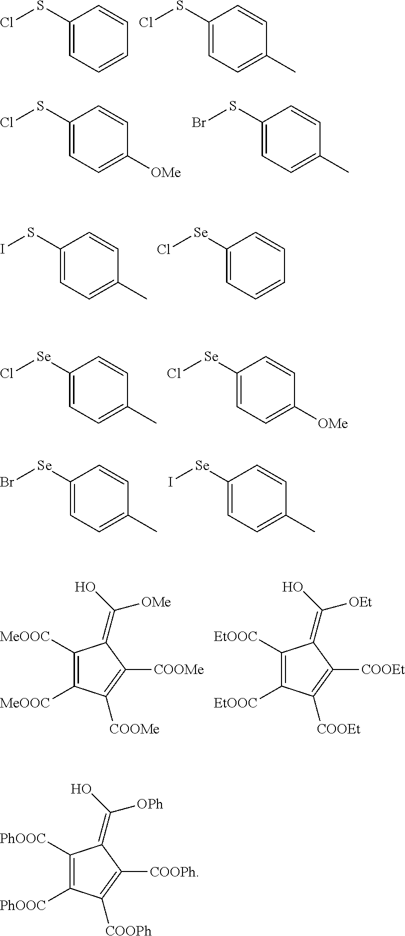

In the technical solution above, preferably, the hydrogen-bond donor comprises one
or more selected from the following general structural formulas:

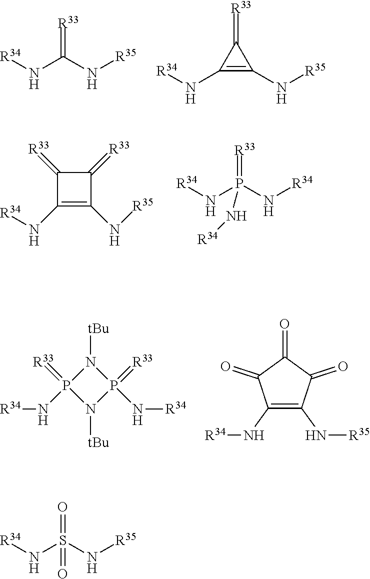

wherein R³³ is defined as one of O, S and Se, R³⁴ and R³⁵ are independently selected from one in hydrogen, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group and a C₅₋₃₀ heteroaryl group;
more preferably, the R³⁴ and R³⁵ are independently selected from one of the following structures:

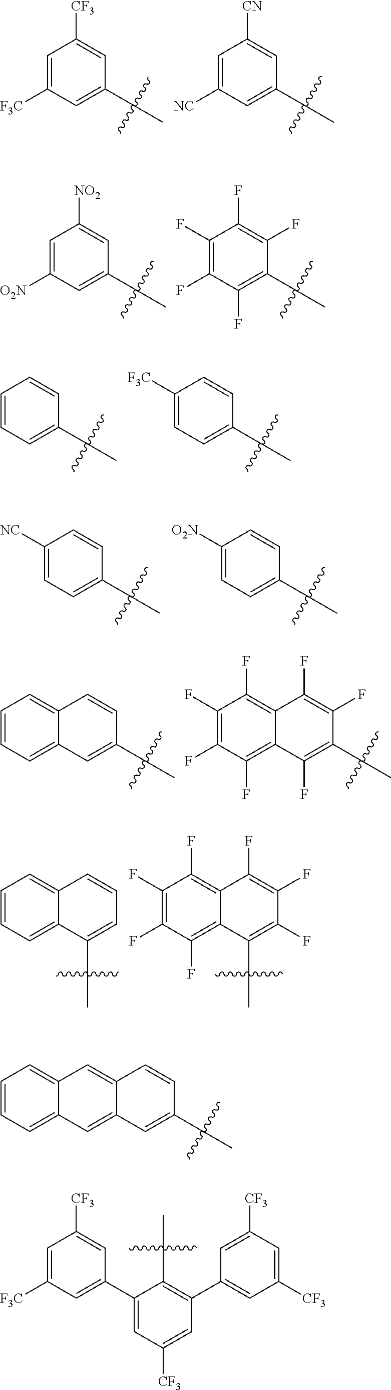

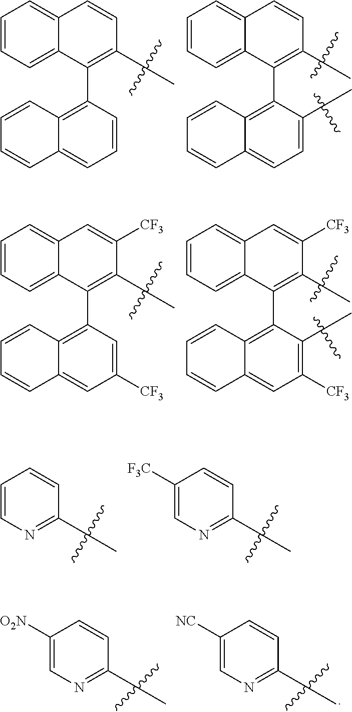

In the technical solution above, most preferably, the hydrogen-bond donor is one or more in the following structures:

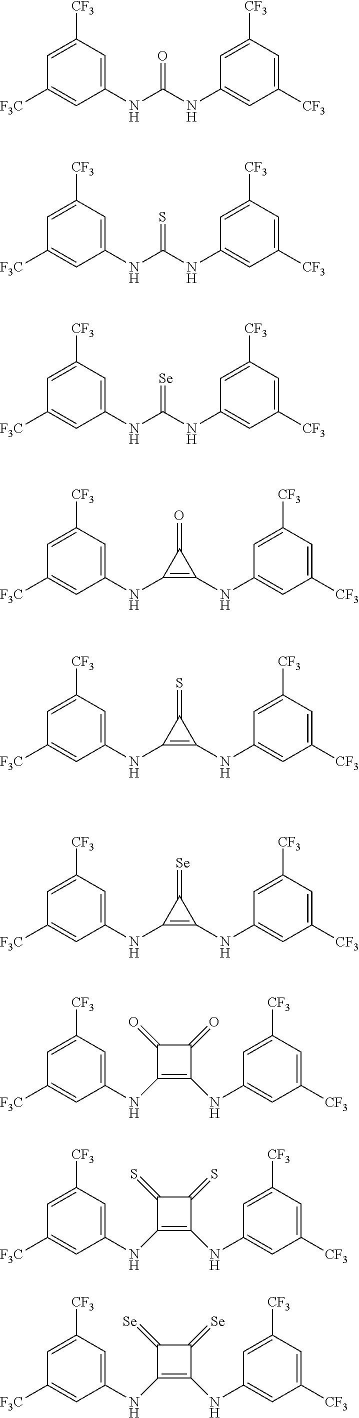

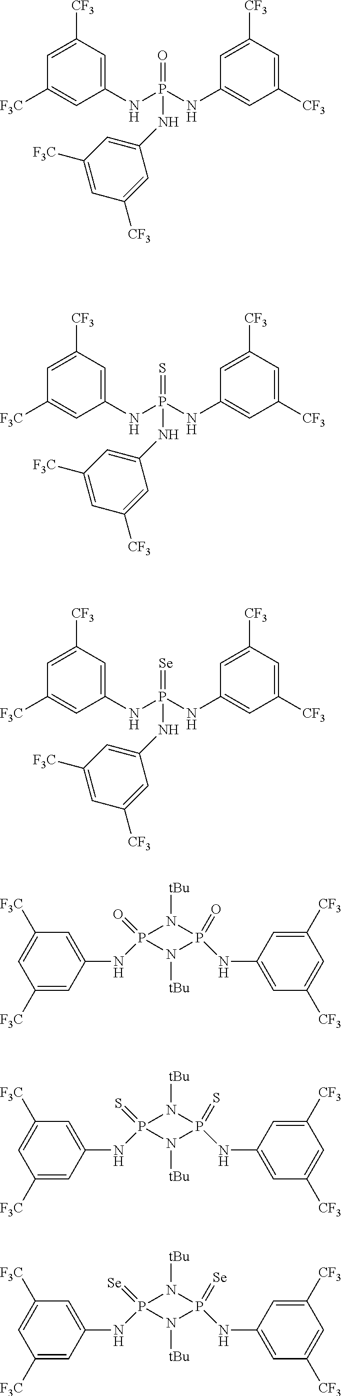

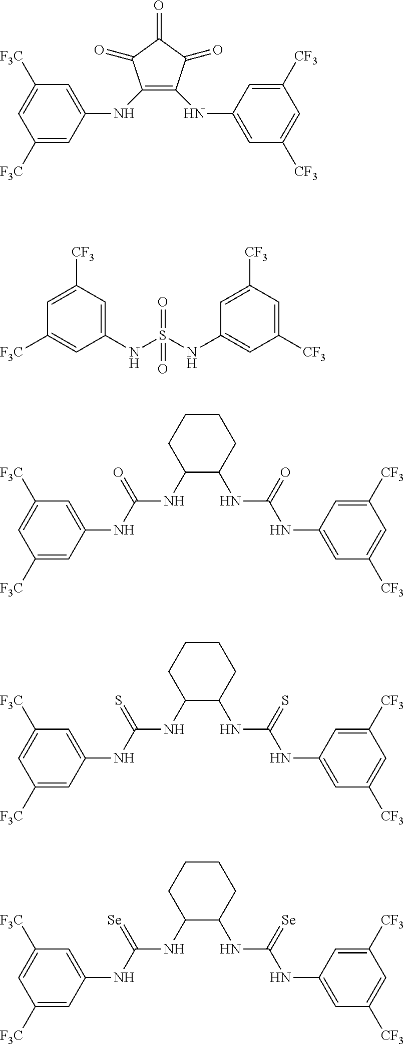

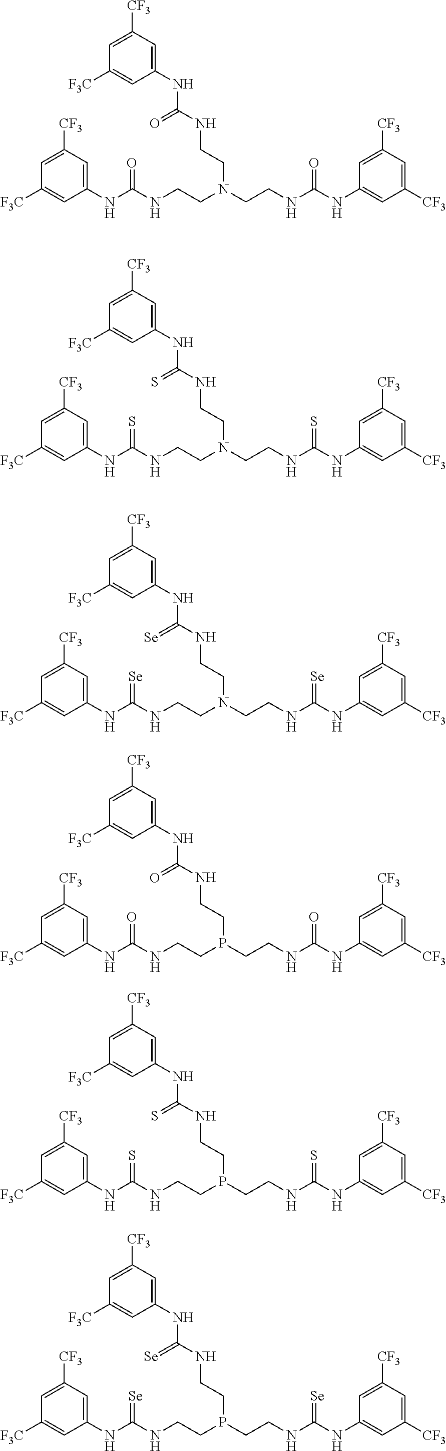

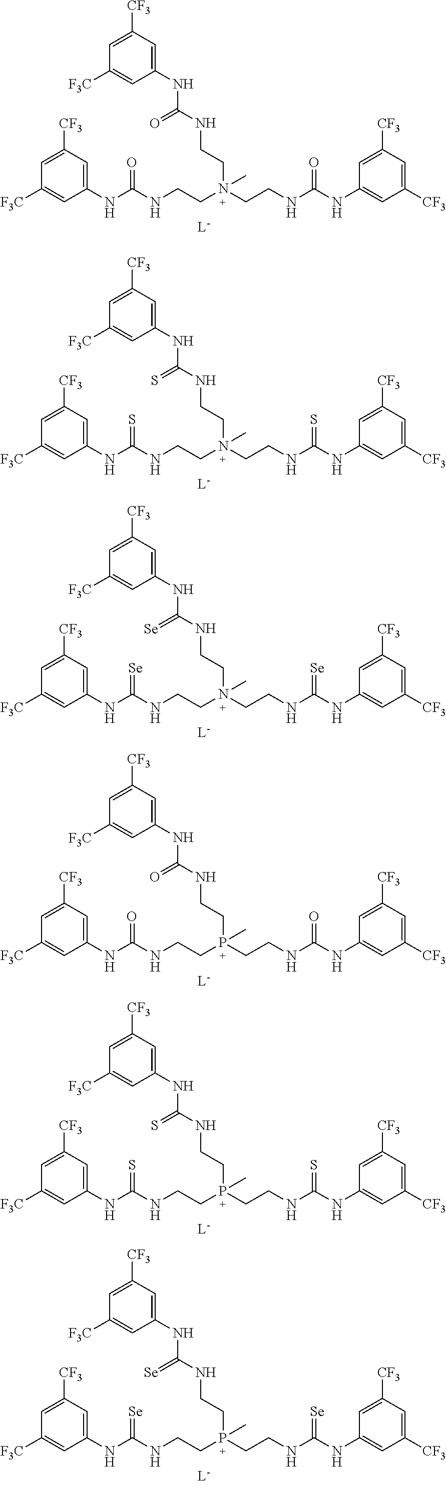

wherein L⁻ is one selected from Cl⁻, Br⁻, I⁻, N₃⁻, BF₄⁻, PF₆⁻, SbF₆⁻, BPh₄⁻, B(C₆F₅)₄⁻and OTf⁻.

In the technical solution above, preferably, the electron-rich ethylenic monomer has a general structural formula as shown below:

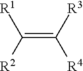

wherein R¹ and R² are independently selected from hydrogen or a C₁₋₆ alkyl group, while at least one of R¹ and R² is a hydrogen atom; R³ and R⁴ are independently selected from hydrogen, a C₁₋₃₀ alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, a C₅₋₃₀ heteroaryl group, OR⁵ or NR⁶R⁷ (R⁶ and R⁷ are defined as one or two selected from a C₆₋₃₀ aryl group);
R⁵ is one selected from C₂H₄OCH₃, C₂H₄Cl, a C₁₋₆ alkyl group and a C₃₋₆ alicyclic hydrocarbon group; R⁶ and R⁷ are both a C₆₋₃₀ aryl group.

More preferably, the electron-rich ethylenic monomer is one or more selected from a vinyl ether, isobutylene, butadiene, isoprene, styrene, a styrene derivative, and vinyl carbazole.

In the technical solution above, most preferably, the electron-rich ethylenic monomer is one or more selected from the following structures:

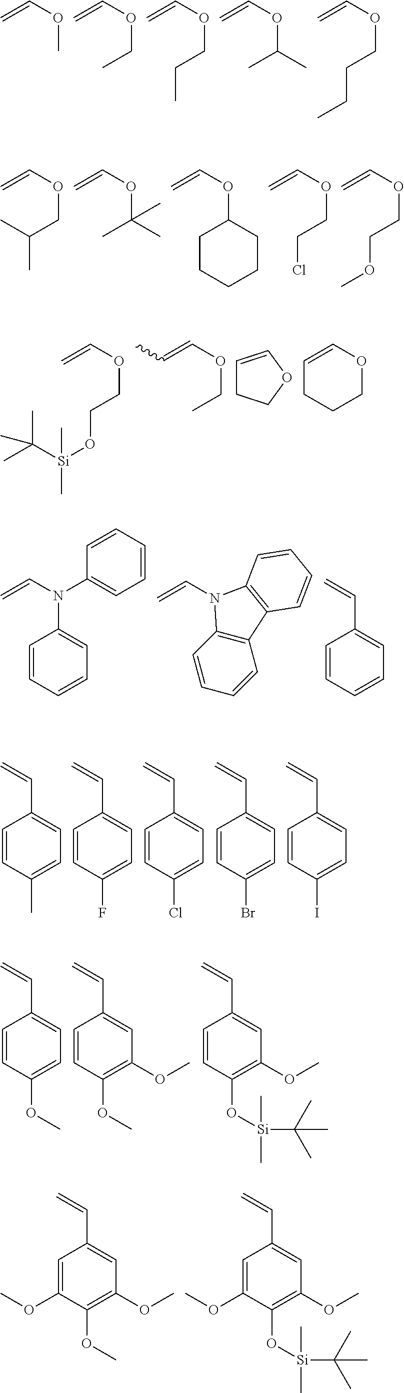

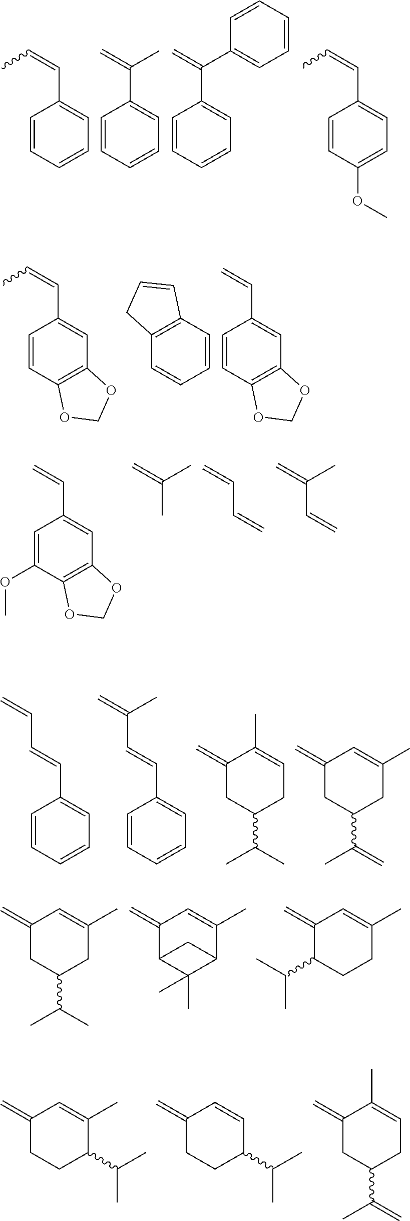

in the above structures, the mark [symbol] represents that a substitute group has a chiral spatial configuration of an R configuration or an S configuration, or that a double bond has a spatial configuration of Z configuration or E configuration.

In the technical solution above, preferably, the other monomer capable of being polymerized by cationic polymerization is one or more selected from the following general structural formulas:

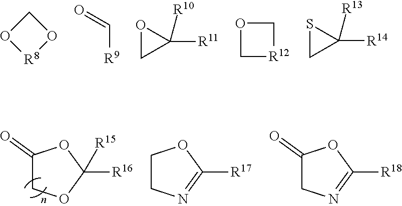

wherein R⁸, R⁹, R¹⁰, R¹¹, R¹², R¹³, R¹⁴, R¹⁵, R¹⁶, R¹⁷, R¹⁸ are independently selected from hydrogen, a halogen atom, C₆F₅, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, or a C₅₋₃₀ heteroaryl group; n is a positive integer of 1 to 5.

In the technical solution above, more preferably, the other monomer capable of being polymerized by cationic polymerization is one or more selected from the following structures:

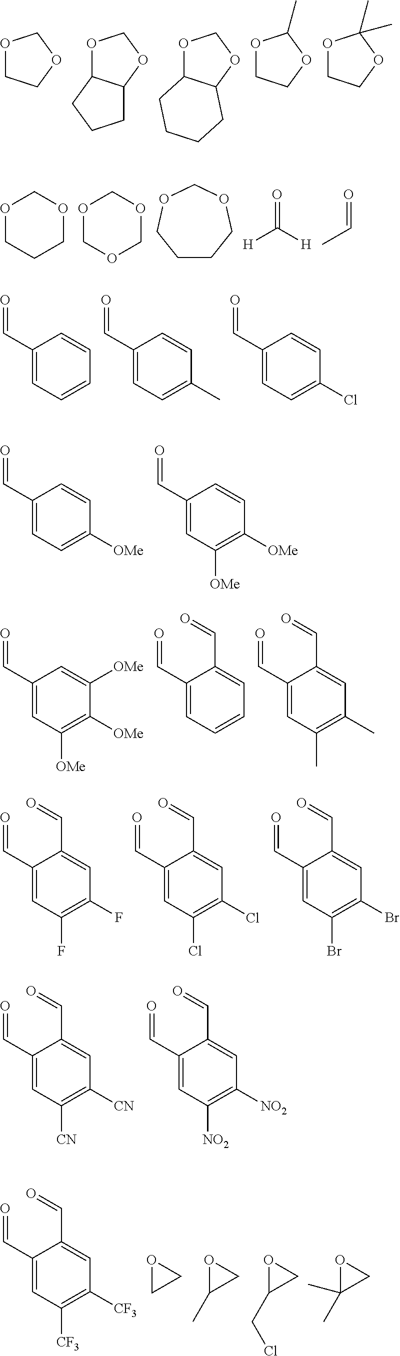

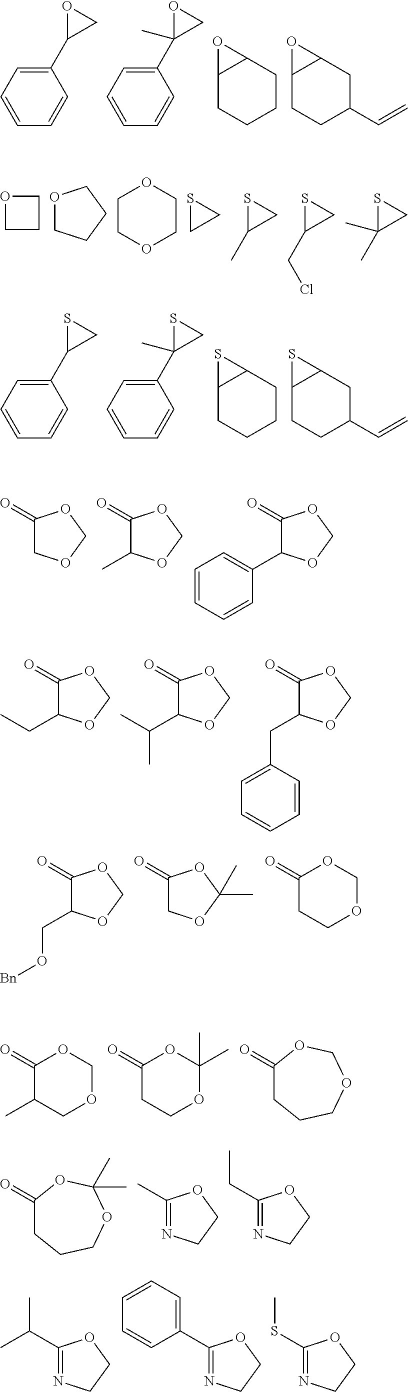

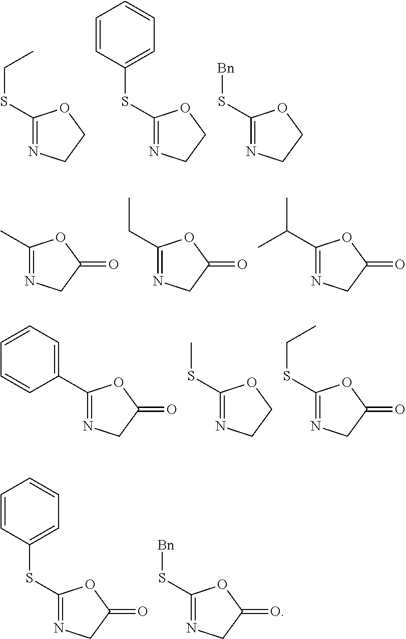

In the technical solution above, preferably, the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

The present application has the following beneficial effects.
(1) The present application provides a method of performing living cationic polymerization of monomers by supermolecular anion-binding catalysis, wherein the method provides a novel mechanism and route of catalysis for polymerization, i.e., realizing catalysis for polymerization by binding and dissociating anions dynamically by the supermolecular anion-binding interaction.
(2) The present application provides a method of performing living cationic polymerization of monomers by supermolecular anion-binding catalysis, wherein the method may catalyze electron-rich ethylenic monomers or other monomers capable of being polymerized by cationic polymerization, to perform living cationic polymerization, and control the molecular weight, molecular weight distribution and end group structure of the obtained polymer product precisely.
(3) The present application provides a method of performing living cationic polymerization of monomers by supermolecular anion-binding catalysis, wherein the method may realize cationic polymerization having controllable activity under mild conditions, does not need harsh polymerization reaction conditions (such as low temperature, inert atmosphere and strict purification of the reagents), and has no metal residue.

### BRIEF DESCRIPTION OF DRAWINGS

The present application is further illustrated in details below in combination with figures and embodiments.

FIG. 1 is a diagram showing the catalysis mechanism for polymerization of the polymerization method by the supermolecular anion-binding catalysis of the present application.

FIG. 2 is a diagram of the nuclear magnetic hydrogen spectrum of polyisobutyl vinyl ether.

FIG. 3 is a high-resolution MALDI-TOF-MS diagram of polyisobutyl vinyl ether.

FIG. 4 is a schematic diagram of the polymerization dynamics of polyisobutyl vinyl ether.

### DETAILED DESCRIPTION

The concept of the present application is as follows. Anion-binding interaction is a kind of typical non-covalent effect, and the main form thereof is the bonding between a hydrogen-bond donor and an anion, which has a moderate binding energy. It plays an important role in a lot of biochemical reactions in nature (Chem. Soc. Rev. 36, 348-357, (2007)). In the past decade, chemists have initially explored the use of these dynamic, non-covalent interactions in catalysis, and discovered that a hydrogen-bond donor may extract and bind the counter anion from the ion pairs to realize activation of catalysis, and provide high activity and selectivity to the reaction (Chem. Soc. Rev. 38, 1187-1198 (2009); Nat. Chem. 4, 603-614 (2012); Angew. Chem. Int. Ed. 52, 534-561 (2013); Nature 543, 637-646 (2017)). Because this non-covalent activation mode has lower binding effect energy than the activation by metal-based Lewis acid, it is easier to realize rapid binding and dissociation to the anion species, so that catalytic conversion may be achieved in a high efficiency and a high selectivity under mild conditions. However, the research of anion-binding catalysis was only limited to synthesis and conversion of small molecules. In the term of polymerization reactions, which involve hundreds of steps of small molecule reaction, the research is almost blank. Although there are a lot of documents reporting using a hydrogen-bond donor to activate a neutral substrate (such as a monomer or a propagating chain end or the like) to perform catalysis for polymerization (J. Am. Chem. Soc. 127, 13798-13799 (2005); J. Am. Chem. Soc. 137, 12506-12509 (2015); Nat. Chem. 8, 1047-1053 (2016); J. Am. Chem. Soc. 141, 281-289 (2019)), the mechanism, route or method, which realizes living cationic polymerization by the anion-binding catalysis mechanism, has not been found.

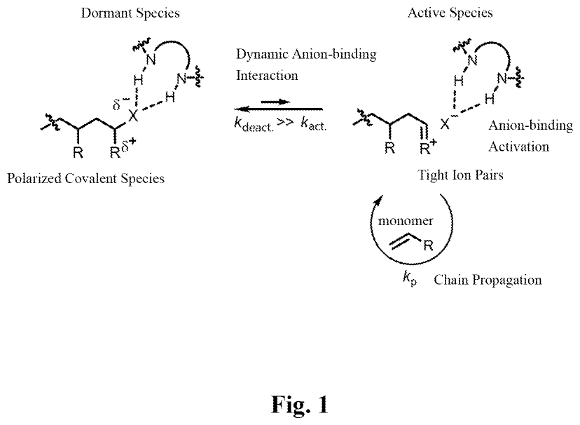

On the basis of above, the present application provides a new method of performing living cationic polymerization by catalyzing an electron-rich ethylenic monomer and other monomer capable of being polymerized by cationic polymerization based on supermolecular anion-binding interaction. Regarding the mechanism of the catalysis of polymerization, please see FIG. 1. The present application uses various simple Bronsted acids or adducts thereof with monomers as the cation initiating system (initiator), and various donors for hydrogen bond as the catalyst for binding and dissociating counter anions dynamically. In the present application, the hydrogen-bond donors may activate dormant covalent bonds dynamically and reversibly under mild conditions by the non-covalent anion-binding interaction, and further controls precisely the equilibrium and conversion between the dormant species and the cationic active species, so as to realize the precise control of the molecular weight (Mⁿ up to 10₅ g/mol), molecular weight distribution (M_{w}/Mₙ<1.20) and end group structure of the polymer, and to solve the environment-unfriendly relevant problems (such as an extreme low polymerization temperature, restrict anhydrous requirement of the reaction, strict purification requirement of the monomer and catalysis-initiating system, metal residue in polymer or the like) in traditional metal-based Lewis acid catalysis. The catalysis method for polymerization of the present application may be used in green synthesis of homopolymers and block or random copolymers of polyvinyl ether, polyvinylcarbazole, polyiso-butylene, polybutadiene, polyisoprene, polystyrene and a derivative thereof, polyether, polythioether, polyacetal, polyazlactone, polyacetal ester, polyoxazoline, and the like, of which the structure is controllable.

The present application provides a method of performing living cationic polymerization of monomers by supermolecular anion-binding catalysis, characterized by comprising the following steps of:
in the presence of a cationic initiator and a hydrogen-bond donor, polymerizing one or more electron-rich ethylenic monomers or other monomers capable of being polymerized by cationic polymerization with a controllable activity to form a homopolymer or a copolymer;
the cationic initiator is an initiator capable of generating a cationic active species by an effect of the hydrogen-bond donor;
the hydrogen-bond donor is a hydrogen-bond donor capable of extracting and binding a counter anion from the cationic initiator or a chain end of a dormant polymer to generate the cationic active species by a supermolecular anion-binding interaction, to realize instant reversible conversion between a dormant species and the cationic active species, and to facilitate a polymerization reaction between the cationic active species and a monomer capable of being polymerized by cationic polymerization.

The hydrogen-bond donor of the present application may extract and bind counter anions from the covalent precursor (called as a cation source or a dormant species), to generate cationic active species and facilitate indirectly the polymerization thereof with the monomers capable of being polymerized by cationic polymerization. Particularly, the hydrogen-bond donor of the present application has following characteristics: (1) The hydrogen-bond donor is designed elaborately, and the Lewis acidity thereof is significantly weaker than that of metal-based Lewis acid, but it is enough to extract anions from the cation source, so that an extremely low concentration of cationic active species is remained and chain propagation under mild conditions is enabled; (2) The hydrogen-bond donor may stabilize ion pairs intermediate dynamically by the anion-binding interaction, realize rapid equilibrium with the dormant species, and facilitate the reversible instant conversion between the dormant species and the cationic active species; (3) The hydrogen-bond donor may disperse the charges of the anions by the anion-binding interaction to reduce the alkalinity thereof, so as to suppress the potential chain transfer and chain termination side reactions; (4) The structure of the hydrogen-bond donor may be easily modified to adjust the anion-binding interaction, which is convenient for further optimization of the catalyst.

In the present application, preferably, the cationic initiator is a Bronsted acid, an adduct of a Bronsted acid with a monomer, or another adduct;
the Bronsted acid has a general structural formula of H—X;
wherein X is selected from Cl, Br, I, ClO₄, BrO₄, IO₄, CN, N₃, (C₆F₅)₄B, SCN, NO₂, PF₆, BF₄, SbF₆, R¹⁹COO, R²⁰SO₃, OP(═O)(OR²¹)₂, SC(═S)NR²², OR²³, SR²⁴ or N(SO₂R²⁵)₂;
R¹⁹, R²⁰, R²¹, R²², R²³, R²⁴ and R²⁵ are independently selected from hydrogen, a halogen atom, CN, SCN, NO₂, C₆F₅, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group or a C₅₋₃₀ heteroaryl group.

As further defined, the most preferable structure of the Bronsted acid in the present application is one selected from the following structures:

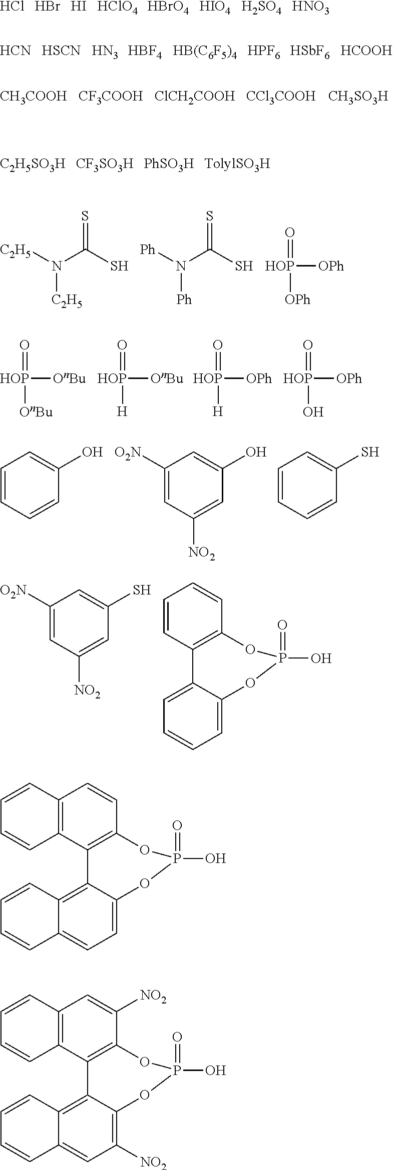

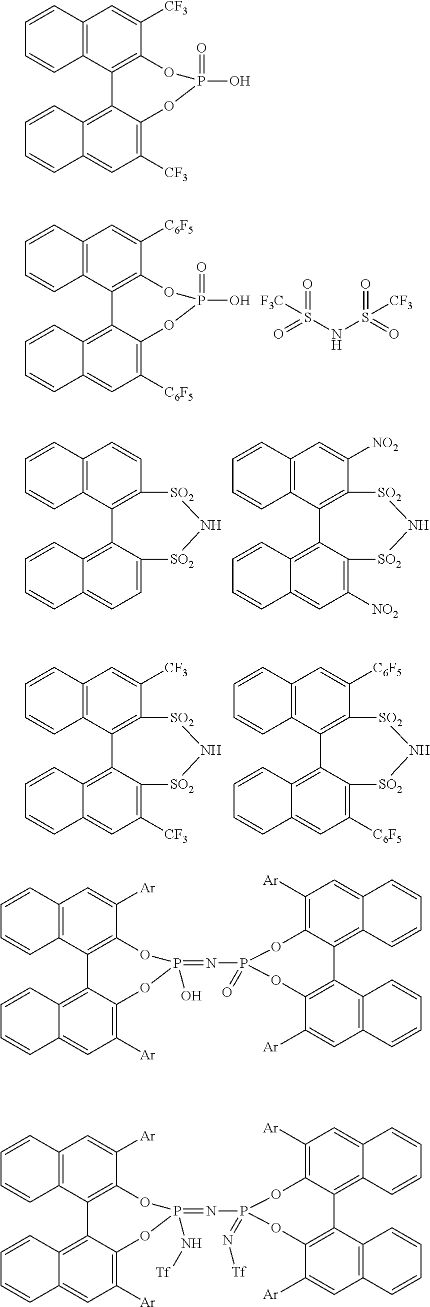

wherein Ph represents phenyl, ⁿBu represents n-butyl, tolyl represents tolyl, Ar represents aryl (defined as above, the most preferably, phenyl, trimethylphenyl, triethylphenyl, triisopropylphenyl, di-tert-butylphenyl), Tf represents trifluoromethanesulfonyl.

The adduct of a Bronsted acid with a monomer, or another adduct is one or more selected from the following general structural formulas:

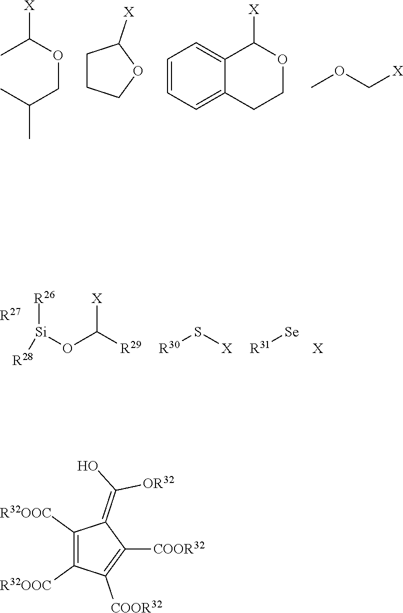

wherein X has a definition as above, R²⁶, R²⁷, R²⁸, R²⁹, R³⁰, R³¹ and R³² are independently selected from hydrogen, a C₁₋₃₀ alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, or a C₅₋₃₀ heteroaryl group.

As further defined, the adduct is one or more selected from the following structures:

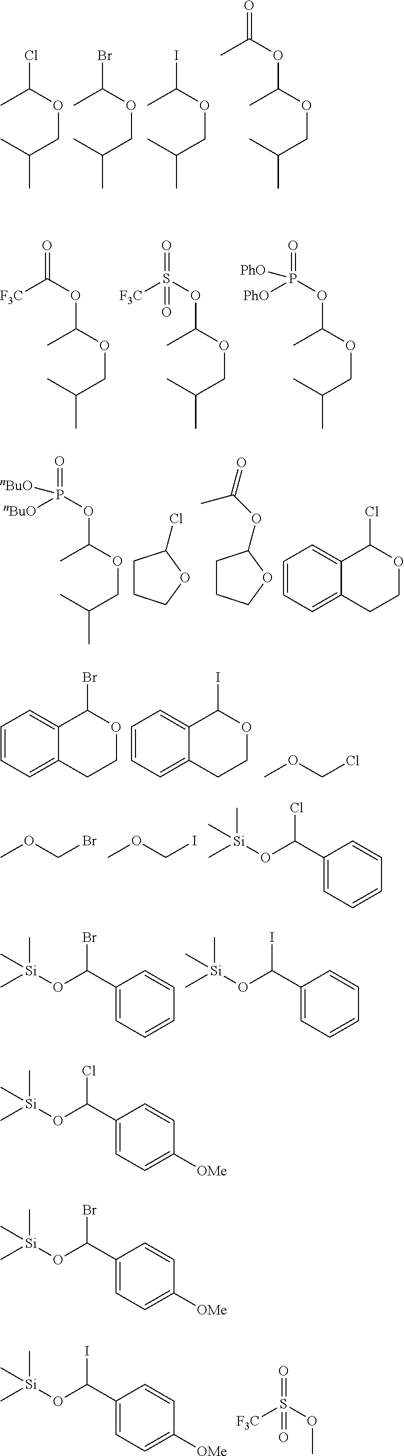

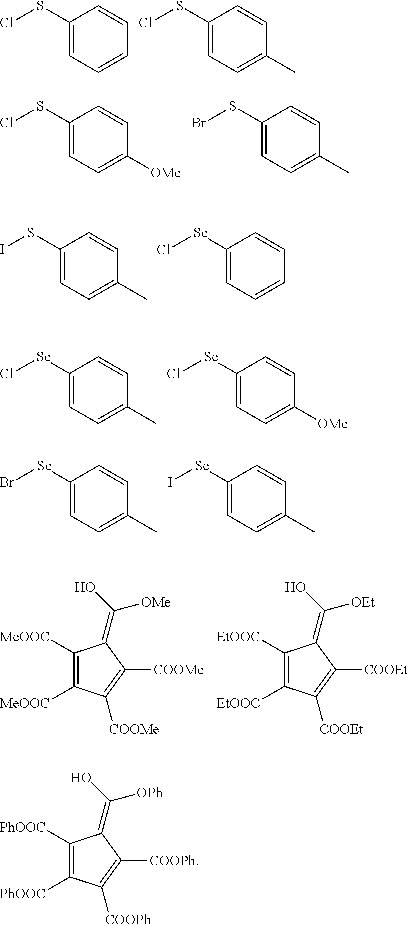

The hydrogen-bond donor used in the present application may extract and bind counter anions from the cation initiator system or chain end dormant species mentioned above, and the hydrogen-bond donors, which generate cationic active species and the protons therein will not be taken away by the counter anions, are all suitable for the present application. Preferably, the hydrogen-bond donor is one or more selected from the following general structural formulas:

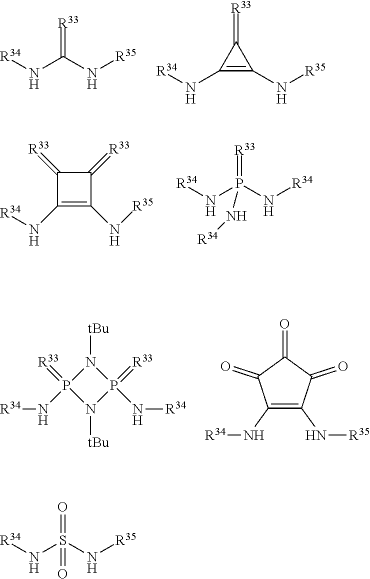

wherein R³³ is defined as one of O, S and Se, R³⁴ and R³⁵ are independently selected from one in hydrogen, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group and a C₅₋₃₀ heteroaryl group.

As further defined, the R³⁴ and R³⁵ are independently selected from one of following structures:

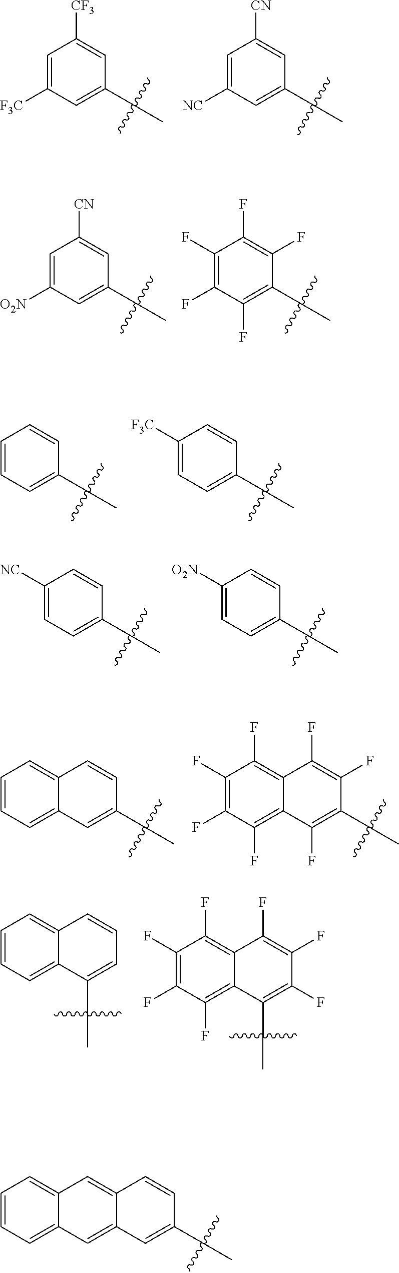

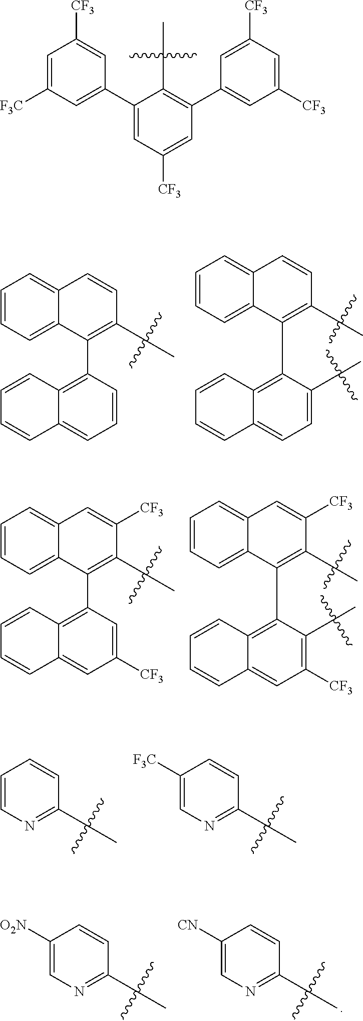

As still further defined, most preferably, the hydrogen-bond donor is one or more in following structures:

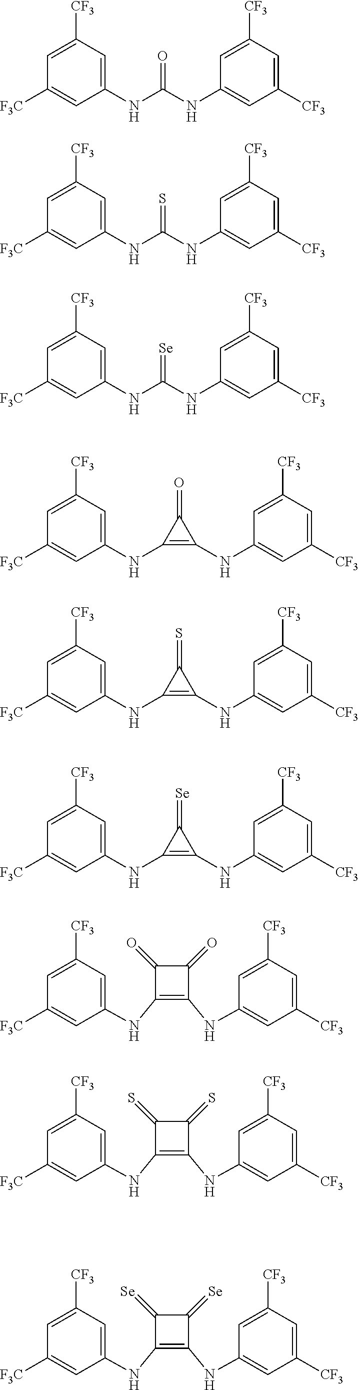

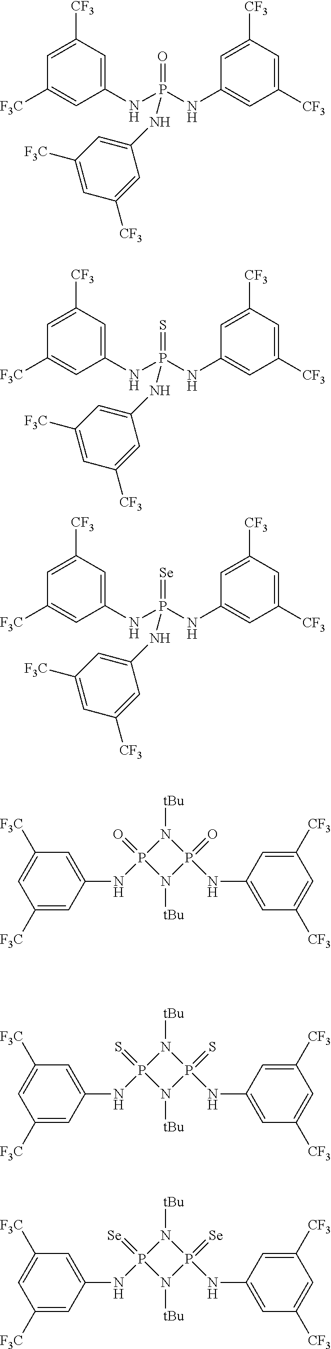

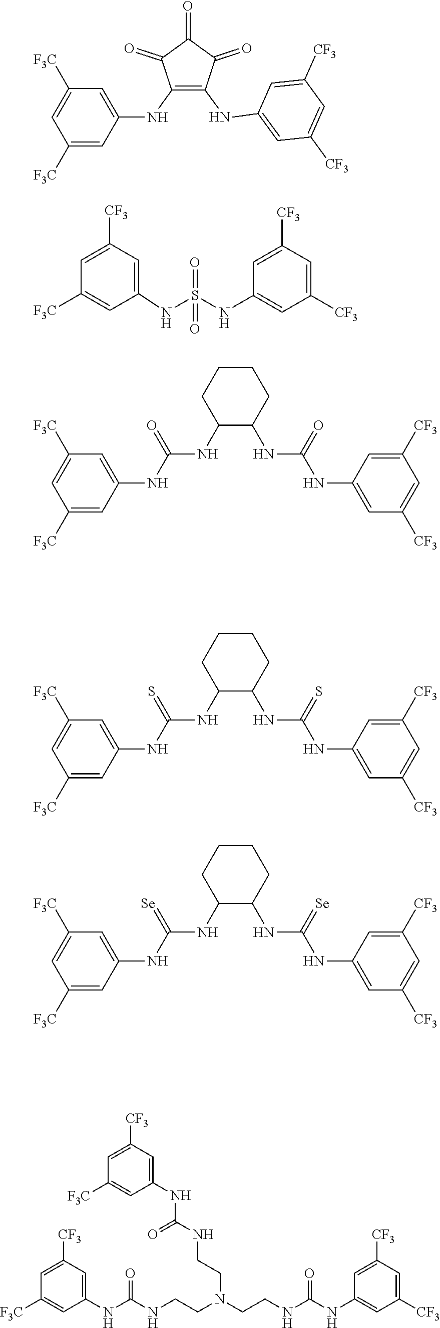

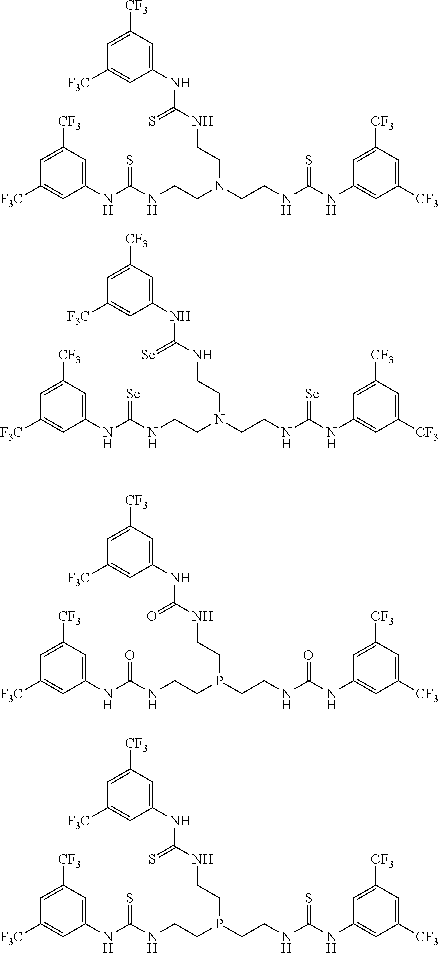

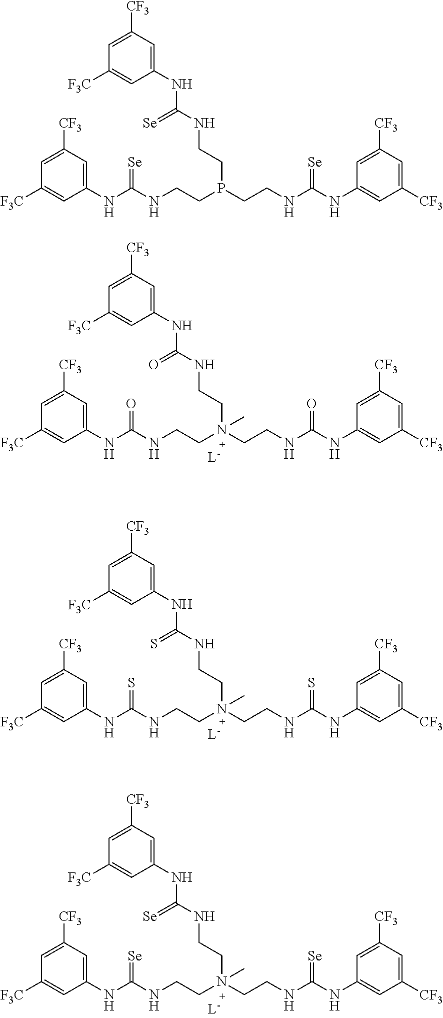

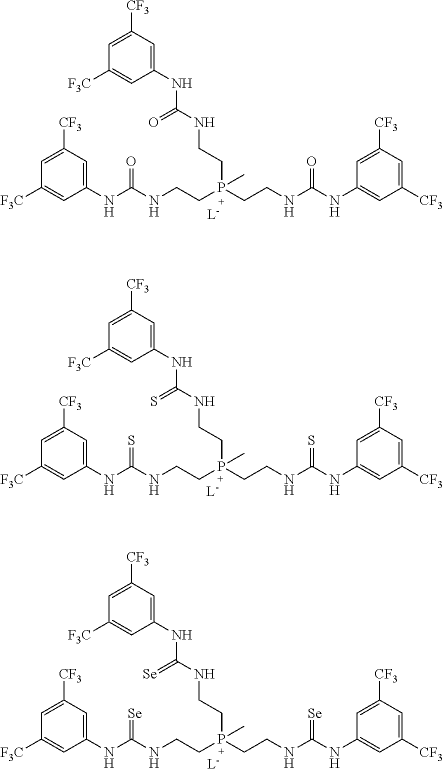

wherein L⁻ is one selected from Cl⁻, Br⁻, I⁻, N₃⁻, BF₄⁻, PF₆⁻, SbF₆⁻, BPh₄⁻, B(C₆F₅)₄⁻ and

The monomers for polymerization of the present application are electron-rich ethylenic monomers or other monomers capable of being polymerized by cationic polymerization, wherein the electron-rich ethylenic monomer has a general structural formula as shown below:

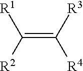

wherein R¹ and R² are independently selected from hydrogen or a C₁₋₆ alkyl group, while at least one of R¹ and R² is a hydrogen atom; R³ and R⁴ are independently selected from hydrogen, a C₁₋₃₀ alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, a C₅₋₃₀ heteroaryl group, OR⁵ or NR⁶R⁷; more preferably, R¹ and R² are independently selected from a C₁ alkyl group, R³ and R⁴ are independently selected from a C₁ alkyl group;
R⁵ is one of C₂H₄OCH₃, C₂H₄C₁, a C₁₋₆ alkyl group and a C₃₋₆ alicyclic hydrocarbon group; R⁶ and R⁷ are both a C₆₋₃₀ aryl group.

In the present application, the alkyl, alkenyl and alkynyl groups have straight chain or branched chain molecular chain structures. The alkyl groups represent phenyl, tolyl, chlorophenyl, methoxyphenyl, dimethoxyphenyl, trimethoxyphenyl, naphthyl, phenanthrenyl, anthracenyl, pyrenyl, biphenyl, binaphthyl. The heteroaryl groups represent pyrrolyl, furyl, thienyl, imidazolyl, thiazolyl, oxazolyl, quinolinyl, isoquinolyl, pyridyl, pyrazinyl, pyrimidinyl, purinyl. Therefore, the preferable electron-rich ethylenic monomers suitable for the present application are one or more selected from a vinyl ether, iso-butylene, butadiene, isoprene, styrene and a derivative thereof, and vinylcarbazole.

Still further, the most preferable electron-rich ethylenic monomers of the present application include one or more selected from the following structures:

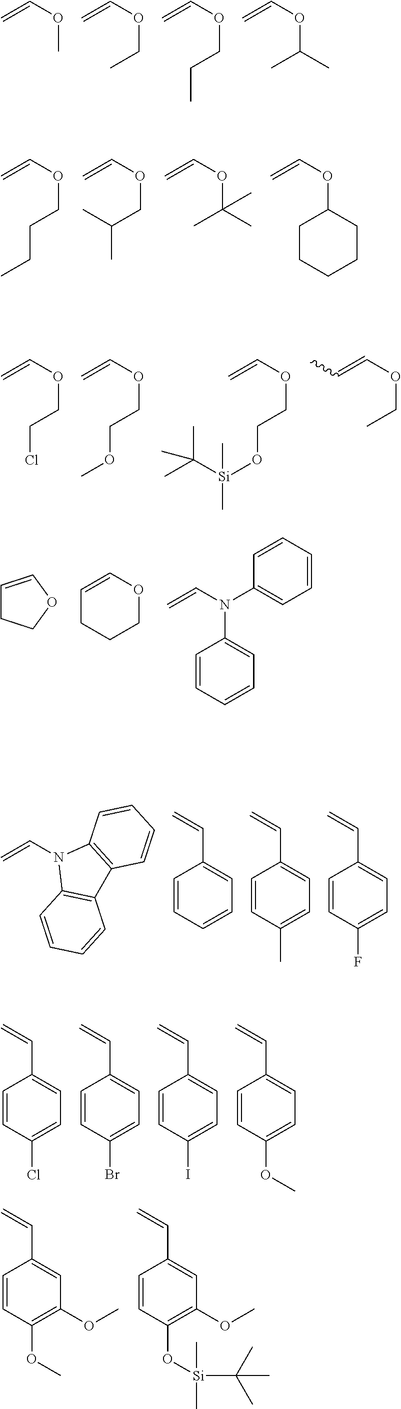

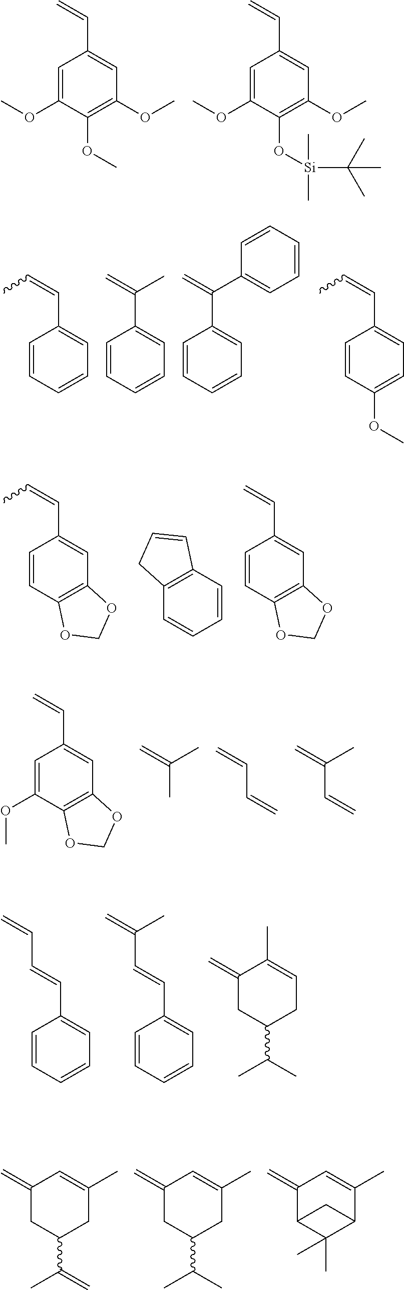

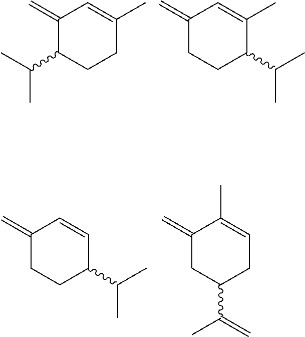

in the structures above, the mark [symbol] represents that a substitute group has a chiral spatial configuration of an R configuration or an S configuration, or that a double bond has a spatial configuration of Z configuration or E configuration.

In the present application, other monomer capable of being polymerized by cationic polymerization except the electron-rich ethylenic monomers is one or more selected from the following general structural formulas:

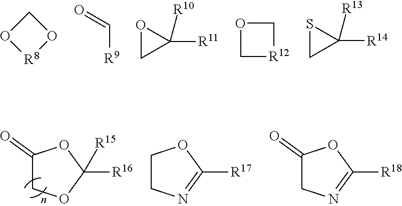

wherein R⁸, R⁹, R¹⁰, R¹¹, R¹², R¹³, R¹⁴, R¹⁵, R¹⁶, R¹⁷, R¹⁸ are independently selected from hydrogen, a halogen atom, C₆F₅, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, or a C₅₋₃₀ heteroaryl group; n is a positive integer of 1 to 5.

More preferably, the most prefer other monomer capable of being polymerized by cationic polymerization is one or more selected from the following structures:

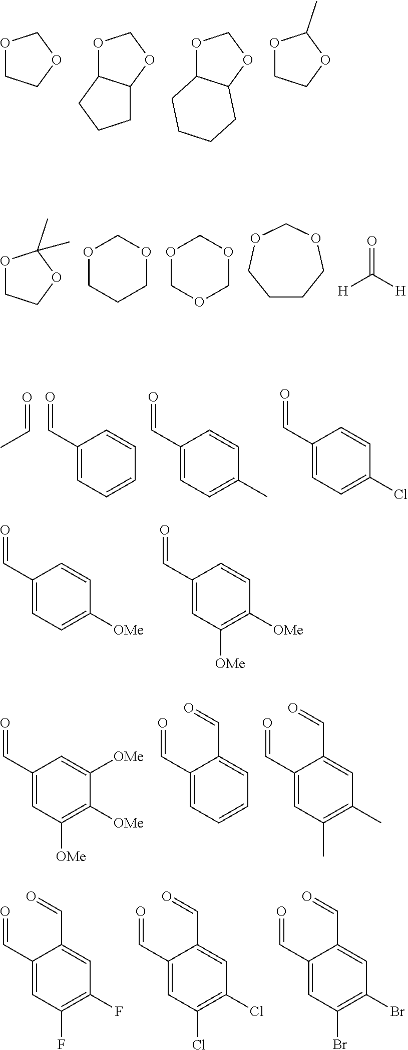

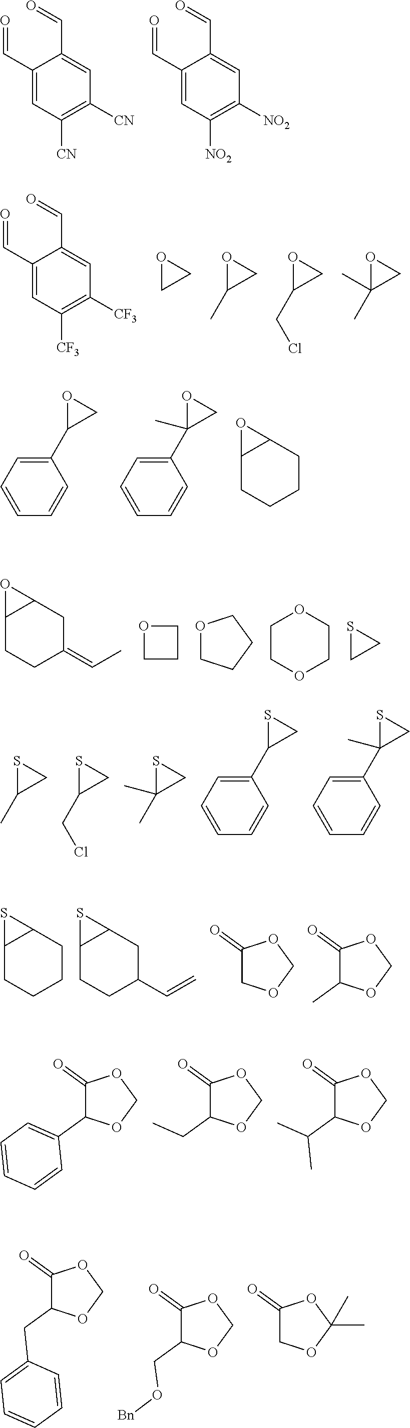

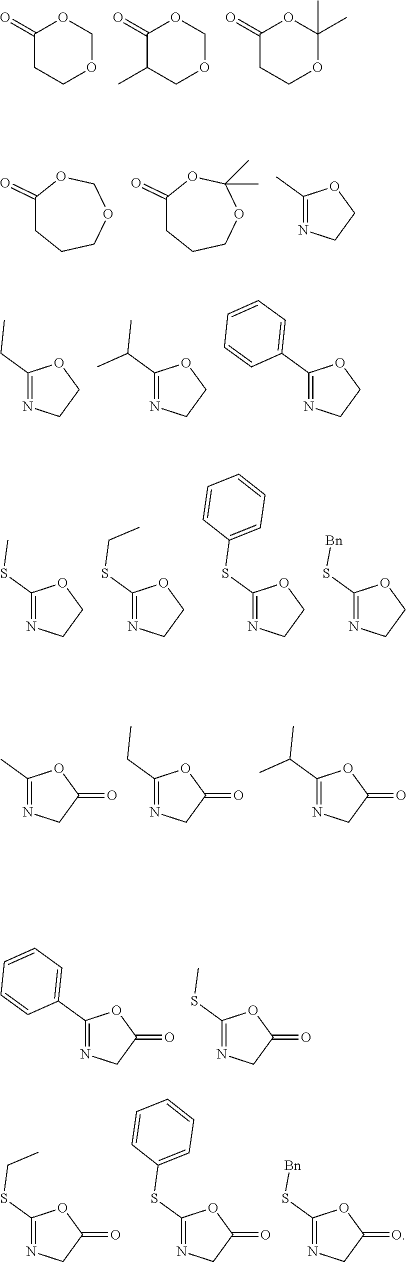

In the cationic polymerization reaction involved by the present application, the amount and relative proportion of the cationic initiator and the hydrogen-bond donor are set appropriately, as long as the living cationic polymerization may be performed effectively. The cationic initiator of the present application generally has a very good initiation efficiency (at least 50%, preferably 80%, most preferably larger than or equal to 90%) through the activation of hydrogen-bond donor. Therefore, the amount of the cationic initiator may be selected, such that the concentration of the cationic initiator is 10⁻⁵ mol/L to 1 mol/L, preferably 10⁻⁴ mol/L to 10⁻¹ mol/L. Or the cationic initiator may be present in a molar ratio of 10^{-4 : 1} to 10⁻¹:1, preferably a molar ratio of 10⁻³:1 to 2×10⁻²:1, with respect to the monomers. A cationic initiator concentration of 0.1 to 1 mol/L is very suitable for producing polymers having functionalized end groups.

In the cationic polymerization reaction involved by the present application, the molar ratio of the hydrogen-bond donor catalyst to the cationic initiator is generally a molar ratio, which enables effective polymerization of the selected monomers. The ratio of between the both may be 0.0001:1 to 10:1, preferably 0.1:1 to 5:1, more preferably 0.3:1 to 2:1, most preferably 0.4:1 to 1.1:1. The polymerization in a homogeneous phase system may allow the concentration of the hydrogen-bond donor to be decreased, so that the molar ratio of the catalyst to the initiator is reduced to 0.001:1.

The cationic polymerization involved by the present application may be performed in the case without a solvent, which means bulk polymerization is possible. However, when a solvent is used, the suitable solvents include halogenated alkane solvents having low polarity (such as chloromethane, dichloromethane, dichloroethane, trichloroethane, carbon tetrachloride or the like), non-polar hydrocarbon solvents (such as n-hexane, cyclohexane), aromatic hydrocarbons (such as toluene, xylene, benzene, benzonitrile, chlorobenzene), non-polar ether solvents (such as diethyl ether, methylcyclohexyl ether, tetrahydrofuran), and also include mixed solvents by mixing the solvents above in arbitrary proportions.

In the present application, the keys controlling the polymerization reaction include: (1) matching the reactivity of the initiator to the reactivity of the monomer, (2) matching the energy of breaking the bond and forming the bond of the dormant species to the hydrogen-bond donor catalyst, and (3) suppressing the potential chain transfer and chain termination side reactions.

The matching of reactivity between the cationic initiator and the monomer depends on, in a certain extent, the stabilization effect of the substitutes on the cations. Therefore, in the case that the monomer is vinyl ether (e.g., isobutyl vinyl ether, ethyl vinyl ether, methyl vinyl ether or the like), styrene derivatives, isobutylene, butadiene, isoprene, cyclic acetals, cyclic ethers, cyclic thioethers, a Bronsted acid may be selected as the cationic initiator, and an adduct of a monomer and a Bronsted acid may also be selected as the cationic initiator. In another aspect, if the adduct of the monomer and the Bronsted acid is an unstable adduct, a high activity α-halogenated isochroman or an adduct of halogenated silane and aldehyde may be selected as the cationic initiator. Such “match” between the cationic initiator and the substitute on the monomer provides a beneficial balance of relative reactivities of the cationic initiator and the monomer.

The energy of the bond breaking and bond forming of the dormant species matches the hydrogen-bond donor catalyst, which requires: (1) the Lewis acidity of the elaborately designed hydrogen-bond donor should be weaker than that of the metal-based Lewis acid, but enough to abstract anions from the cationogen, and thereby deliver a very low concentration of the ionic species and allow chain propagation under mild conditions; (2) the ionic intermediate could be dynamically stabilized by the anion-binding interaction to achieve a fast but reversible transformation into the covalent precursor. Preferably, the selection of the monomer, the cationic initiator, and the hydrogen-bond donor allows that the chain propagation rate of the cationic active species is slower than the binding rate of the X group (X group as defined above) to the living end of the cation by no less than a factor of 1000 (preferably no less than a factor of 100). That is, after one monomer propagates, the cationic active species preferably reacts with the X group to form a dormant species, thus enabling the simultaneous growth of each polymer chain during the polymerization process.

Suppression of the potential chain transfer and chain termination side reaction requires building a ternary supermolecular complexes of the monomer, the hydrogen-bond donor and the active chain end by the anion-binding interaction, to stabilize the cation intermediate and the chain propagation transition state, and to disperse the charges of the anions to decrease the basicity thereof, so as to suppress side reactions, such as β-hydrogen elimination.

The polymerization involved by the present application may be performed in a sealed vessel (such as a glass reaction bottle, a Schlenk polymerization tube) or in an autoclave. The polymerization temperature may be −100° C. to 200° C., preferably −78° C. to 100° C., most preferably 0° C. to 25° C. The polymerization reaction should be performed for enough time, such that the conversion rate of the monomer being converted to the polymer is at least 10% (preferably at least 50%, more preferably at least 80%, most preferably at least 95%). Generally, the duration of the polymerization reaction is several seconds to 5 days, preferably 30 minutes to 3 days, most preferably 1 to 24 hours.

After the polymerization step is finished, the formed polymer is separated. The separation steps of the present method are performed by known procedures, and may include precipitating in a suitable solvent, filtering the precipitated polymer, washing the polymer and drying the polymer. Precipitation may generally use suitable C₅-C₈ alkane solvents or C₅-C₈ cyclic alkane solvents, such as pentane, hexane, heptane, cyclohexane or mineral spirits, or use C₁-C₆ alcohols, e.g., methanol, ethanol or isopropanol, or any suitable mixture of solvents. Preferably, the solvent used for precipitation is hexane, hexane mixture or methanol.

The precipitated (co)polymer may be filtered by known processes (such as by using a funnel or an aspirator) by gravity or vacuum filtration. If needed, the solvent for precipitating the polymer may be used to wash the polymer. Precipitation, filtration and washing steps may be repeated according to the requirement. The precipitated (co)polymer may also be collected and deposited by centrifugal and then pouring out the upper and washing the precipitation with the solvent for precipitating. Precipitation, centrifugal and washing steps may be repeated according to the requirement.

Once separation is done, the (co)polymer may be dried by known processes (preferably by vacuum) by blowing air over the (co)polymer or by vacuum. The (co)polymer of the present application may be analyzed and characterized by known programs by size exclusion chromatography, NMR spectroscopy and mass spectrometry.

The present application is further illustrated by referring to the Examples, without applying any limitation to the present application.

Any specific numerical value disclosed herein (including the endpoint of the numerical range) is not limited to the exact value of the numerical value, but should be understood as also covering the value close to the exact value, for example, any possible numerical values within ±5% range of the exact value of the and numerical value. Further, for a disclosed numerical range, one or more new numerical value ranges may be obtained by any combination between the endpoints of the range, between the endpoints and specific point values in the range, and between specific point values. These new numerical value ranges should also be regarded as being explicitly disclosed herein.

Unless otherwise stated, the terms used herein have the same meaning as commonly understood by those skilled in the field, and if the term is defined herein, and its definition is different from the common understanding in the field, then the definition herein prevails.

In the present application, except for the contents explicitly stated, any matters or matters not mentioned are directly applicable to those known in the art without any change. Moreover, any embodiment described herein may be freely combined with one or more other embodiments described herein, and the resulting technical solutions or technical ideas are regarded as a part of the original disclosure or original record of the present application, and should not be regarded as a new content that has not been disclosed or expected herein, unless those skilled in the art think that the combination is obviously unreasonable.

All patent and non-patent documents mentioned herein, including but not limited to textbooks and journal articles, are incorporated herein by reference in their entirety.

If there is no indication to the contrary, the various reagents used in the following Examples are commercially available products, and the purity is analytically pure.

In the following Example, the nuclear magnetic spectra of the obtained polymers were measured by adopting a Burker AV-300, 400M liquid superconducting NMR spectrometer using a deuterated chloroform solvent at room temperature. The number average molecular weight was measured by adopting a Waters515 type size exclusion chromatograph (Waters Corporation, USA).

### Example 1

Living cationic polymerization of isobutyl vinyl ether by supermolecular anion-binding catalysis

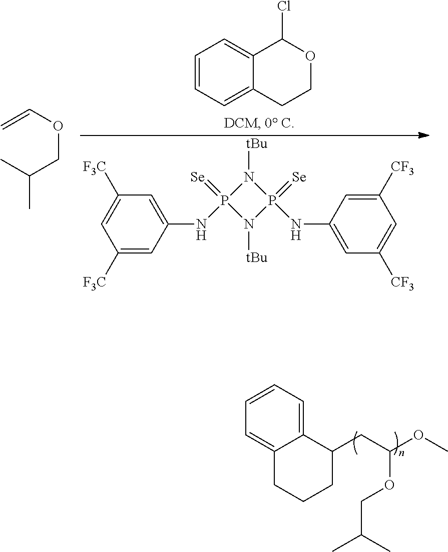

As an effective cationic initiator, a-chloroisochroman (called as ICCl below) was used. As an effective hydrogen-bond donor catalyst, selenocyclophosphamide [3,5-(CF₃)₂C₆H₃NH (Se)P(μ-N^{t}Bu)]₂ (called as catl below) was used. Use of both in cooperation may catalyze isobutyl vinyl ether (IBVE) to perform living cationic polymerization, to realize precise control of the molecular weight (Mₙ up to 10⁵ g/mol), distribution (M_{w}/Mₙ<1.20) and end group structure of the polymer.

The process of polymerization is as follows. Unless otherwise stated, the polymerization was performed in dry nitrogen gas in a schlenk glass tube being baked. The pre-cooled initiator ICCl (dissolved in DCM, 0.02 mmol, 1 equivalent amount) and cat1 (dissolved in DCM, 0.005 mmol, 0.4 equivalent amount) were added to a IBVE monomer solution (dissolved in DCM, 2 mmol, 100 equivalent amount) sequentially by dry injectors, to initiate polymerization. The solution was rapidly stirred at 0° C. After a predetermined time interval, aliquot samples was taken out and terminated by pre-cooled methanol (0.10 mL) comprising a small amount of Et₃N (5% v/v, in MeOH). The conversion rate of the monomer was measured by ¹H NMR spectroscopy, and the molecular weight was measured by size exclusion chromatography (SEC). In order to obtain separated polymer, the solution was subjected to precipitation by using cold methanol. The obtained produce was subjected to centrifugal separation and was dried in vacuum for 24 hours.

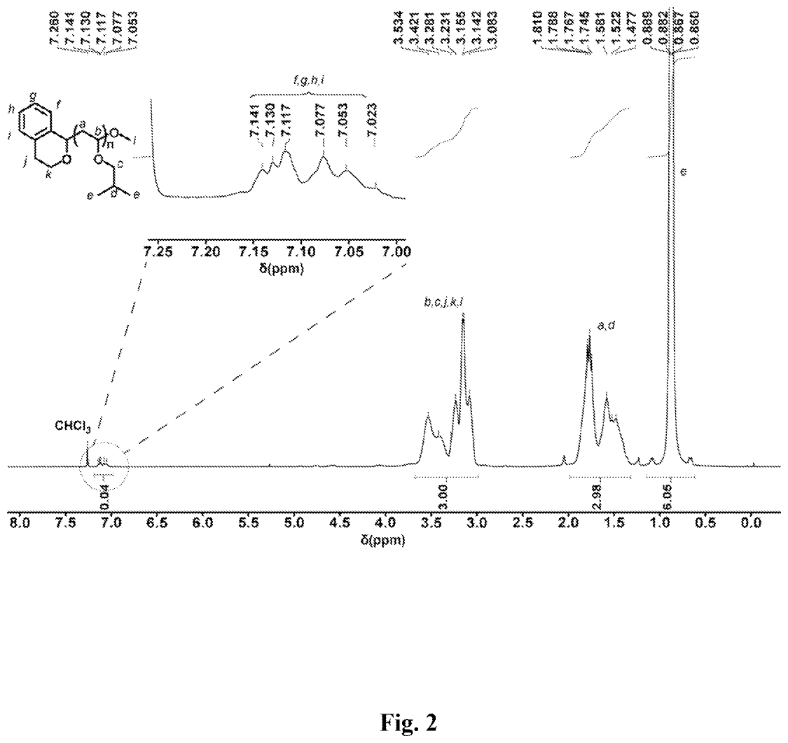

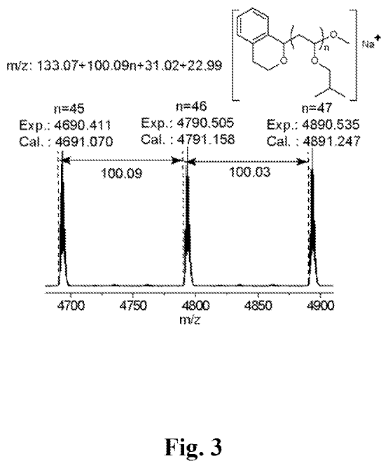

FIG. 2 is a nuclear magnetic hydrogen spectrum of polyisobutyl vinyl ether, and FIG. 3 is high-resolution MALDI-TOF-MS of polyisobutyl vinyl ether. As shown in FIG. 2, in the ¹H NMR of the polymer, the initiator end group of the polymer, i.e., the isochroman group, may be clearly observed. By integral analyzing the nuclear magnetic diagram, it may be known that the molecular weight of the obtained polymer is close to the theoretical value (10.1 kDa), which indicates that all the polymer chains are initiated by the initiator α-chloroisochroman. The analysis result of the high-resolution mass spectrum of the polymer in FIG. 3 may also prove that all the polymer chains are initiated by the initiator α-chloroisochroman, and all the polymer chains are quenched by methanol to form acetal chain ends. In addition, there is only one group of peaks in the high-resolution mass spectrum of the polymer, which indicates that the chain transfer and chain termination side reactions during the polymerization process are effectively suppressed.

The key data in the application Examples are summarized in Table 1. As shown in Table 1, change of the ratio of the monomer to the initiator may effectively adjust the molecular weight of the polymer. The molecular weight increases linearly with the ratio of the monomer/initiator, while a narrow molecular weight distribution (M_{w}/Mₙ<1.20) is remained. Increase of the catalyst concentration while remaining the ratio of the monomer to initiator may increase the polymerization rate significantly, while the molecular weight of the polymer is not influenced. The polymerization reaction has excellent tolerance: (1) When the polymerization is performed by using an unpurified monomer and solvent, similar control of the polymerization may be obtained; (2) When the polymerization is exposed to air, similar control of the polymerization may be obtained; (3) The controllability of the polymerization is not influenced by increasing or decreasing the temperature of the polymer.

TABLE 1
Representative results for living cationic polymerization of isobutyl
vinyl ether by supermolecular anion-binding catalysis ^{a}

| | | | Time | | Conv. | M_{n, calc.} | M_{n, SEC} | Ð |
|---|---|---|---|---|---|---|---|---|
| Entry | Cat. | [M]₀/[cat.]₀/[I]₀ | (h) | | (%)^{b} | (kg/mol) ^{c} | (kg/mol) ^{d} | (M_{w}/Mₙ) ^{d} |
| 1 | Cat | 100:0.4:1 | 0.5 | | >99 | 10.1 | 9.5 | 1.11 |
| 2 | Cat | 50:0.2:1 | 0.5 | | >99 | 5.1 | 6.8 | 1.11 |
| 3 | Cat | 100:0.8:1 | 10 | min | >99 | 10.1 | 10.3 | 1.15 |
| 4 | Cat | 100:1:1 | 5 | min | >99 | 10.1 | 10.0 | 1.13 |
| 5 | Cat | 150:1:1 | 0.5 | | >99 | 15.1 | 16.9 | 1.14 |
| 6 | Cat | 200:1:1 | 1 | | >99 | 20.1 | 20.3 | 1.16 |
| 7 | Cat | 300:1:1 | 2 | | >99 | 30.2 | 28.5 | 1.17 |
| 8 | Cat | 400:1:1 | 5 | | >99 | 40.2 | 37.1 | 1.18 |
| 9^{e} | Cat | 100:100:1: | 5 | min/ | >99/>9 | 10.1/20. | 9.9/21.9 | 1.15/1.1 |

| | | | | | | | |
|---|---|---|---|---|---|---|---|
| 10^{f} | Cat | 100:0.4:1 | 0.5 | >99 | 10.1 | 11.0 | 1.19 |
| 11^{g} | Cat | 100:0.4:1 | 0.5 | >99 | 10.1 | 11.3 | 1.20 |
| 12^{h} | Cat | 200:1:1 | 0.5 | >99 | 20.1 | 21.0 | 1.22 |
| 13^{h} | Cat | 200:1:1 | 2 | >99 | 20.1 | 20.7 | 1.17 |
| 14^{h} | Cat | 200:1:1 | 4 | >99 | 20.1 | 22.8 | 1.15 |
| 15 | Cat | 800:1:1 | 24 | >99 | 80.1 | 79.2 | 1.14 |
| 16 | Cat [symbol] | 1200:1:1 | 24 | >99 | 120.1 | 113.0 | 1.20 |

^{a} If there is no other explanation, ICCl was used as the cationic initiator in nitrogen atmosphere to perform polymerization in the implementation of the cationic polymerization of IBVE monomers, wherein the monomer concentration was 2.0 mol/L, and the polymerization temperature was 0° C.
^{b}The conversion rate of monomers was tested by nuclear magnetic ¹H NMR.
^{c} M_{n, calcd.} = 100.16 × [M]₀/[I]₀ × Conv. + 133.17 + 31.03.
^{d} A small amount of polymerization reaction liquid was taken out, and an SEC test was performed after quenching (THF, 35° C., calibrated by polystyrene).
^{e}Chain propagation experiment was performed by adding the monomers sequentially.
^{f}The polymerization was performed in air atmosphere (open mouthed).
^{g}DCM, which was not dried (moisture content 465 ppm), was used as the solvent, and commercial IBVE, which was not dried, was used as the monomer.
^{h}In polymerization Examples having the number 12, 13, 14, polymerization was performed at 25° C., −20° C., −40° C., respectively. [symbol]
indicates data missing or illegible when filed

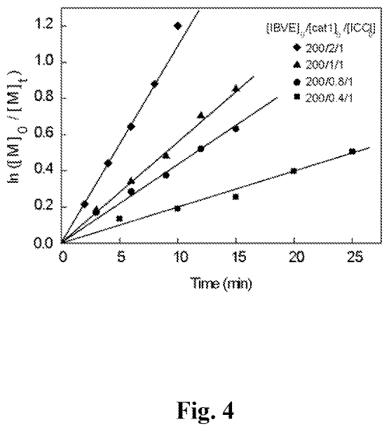

FIG. 4 is the diagram of the polymerization dynamics of polyisobutyl vinyl ether. As shown in FIG. 4, the result of the polymerization dynamics shows that the orders of reaction of the monomer, the catalyst cat1 and the initiator ICCl are all 1, and the entire rate equation is

−d[IBVE]/dt=kₚ[cat1]^{1.09}[ICCl]¹¹⁴[IBVE]ₜ (1)
wherein kₚ is the chain propagation rate constant.

The results above indicate that if ICCl is used as the cationic initiator and cat1 is used as the hydrogen-bond donor catalyst, isobutyl vinyl ether (IBVE) may be catalyzed to perform cationic polymerization having controllable activity, so as to realize the precise control of the molecular weight (Mₙ up to 10⁵ g/mol), distribution (M_{w}/Mₙ<1.20) and end group structure of the polymer, and the polymerization process does not need harsh reaction conditions (such as low temperature, inert atmosphere and strict purification of the reagents), and there is no metal residue in the polymerization product.

### Example 2

Living cationic polymerization of ethyl vinyl ether by supermolecular anion-binding catalysis

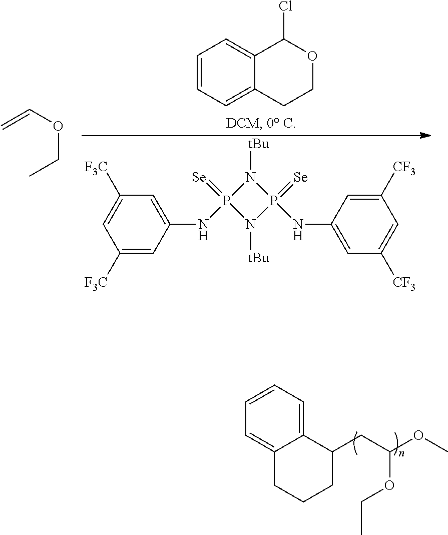

The process of polymerization is as follows. In a schlenk glass tube being baked, the pre-cooled initiator ICCl (dissolved in DCM, 0.02 mmol, 1 equivalent amount) and cat1 (dissolved in DCM, 0.005 mmol, 0.4 equivalent amount) were added to an ethyl vinyl ether monomer solution (dissolved in DCM, 2 mmol, 100 equivalent amount) sequentially by dry injectors, to initiate polymerization. The solution was rapidly stirred at 0° C. After a predetermined time interval, aliquot samples was taken out and terminated by pre-cooled methanol (0.10 mL) comprising a small amount of Et₃N (5% v/v, in MeOH). The conversion rate of the monomer was measured by ¹ H NMR spectroscopy, and the molecular weight (Mₙ=7.6 kDa, M_{w}/Mₙ=1.12) was measured by size exclusion chromatography (SEC). In order to obtain separated polymer, the solution was subjected to precipitation by using cold methanol. The obtained produce was subjected to centrifugal separation and was dried in vacuum for 24 hours.

### Example 3

Living cationic polymerization of 2,3-dihydrofuran by supermolecular anion-binding catalysis

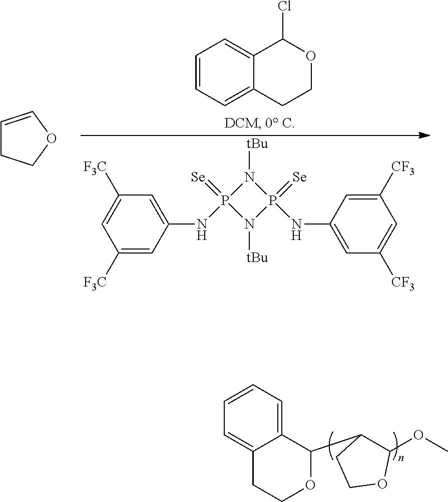

The process of polymerization is as follows. In a schlenk glass tube being baked, the pre-cooled initiator ICCl (dissolved in DCM, 0.02 mmol, 1 equivalent amount) and cat1 (dissolved in DCM, 0.005 mmol, 0.4 equivalent amount) were added to a 2,3-dihydrofuran monomer solution (dissolved in DCM, 2 mmol, 100 equivalent amount) sequentially by dry injectors, to initiate polymerization. The solution was rapidly stirred at 0° C. After a predetermined time interval, aliquot samples was taken out and terminated by pre-cooled methanol (0.10 mL) comprising a small amount of Et₃N (5% v/v, in MeOH). The conversion rate of the monomer was measured by ¹H NMR spectroscopy, and the molecular weight (Mₙ=8.4 kDa, M_{w}/Mₙ=1.32) was measured by size exclusion chromatography (SEC). In order to obtain separated polymer, the solution was subjected to precipitation by using cold methanol. The obtained produce was subjected to centrifugal separation and was dried in vacuum for 24 hours.

### Example 4

Living cationic polymerization of vinylcarbazole by supermolecular anion-binding catalysis

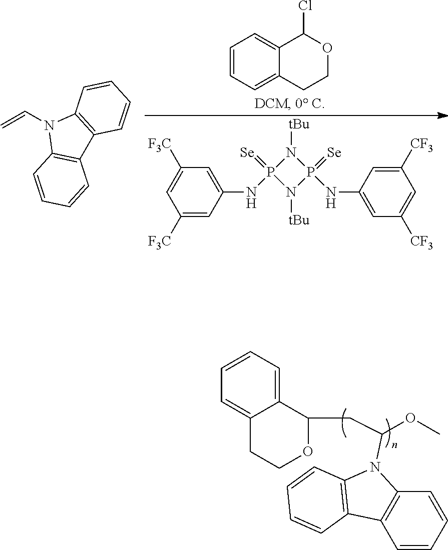

The process of polymerization is as follows. In a schlenk glass tube being baked, the pre-cooled initiator ICCl (dissolved in DCM, 0.02 mmol, 1 equivalent amount) and cat1 (dissolved in DCM, 0.005 mmol, 0.4 equivalent amount) were added to a vinylcarbazole monomer solution (dissolved in DCM, 2 mmol, 100 equivalent amount) sequentially by dry injectors, to initiate polymerization. The solution was rapidly stirred at 0° C. After a predetermined time interval, aliquot samples was taken out and terminated by pre-cooled methanol (0.10 mL) comprising a small amount of Et₃N (5% v/v, in MeOH). The conversion rate of the monomer was measured by ¹ H NMR spectroscopy, and the molecular weight (Mₙ=19.0 kDa, M_{w}/Mₙ=1.30) was measured by size exclusion chromatography (SEC). In order to obtain separated polymer, the solution was subjected to precipitation by using cold methanol. The obtained produce was subjected to centrifugal separation and was dried in vacuum for 24 hours.

### Example 5

Living cationic polymerization of o-phthalaldehyde by supermolecular anion-binding catalysis

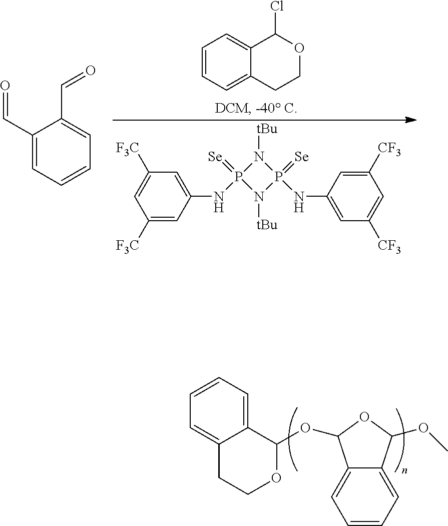

The process of polymerization is as follows. In a schlenk glass tube being baked, the pre-cooled initiator ICCl (dissolved in DCM, 0.02 mmol, 1 equivalent amount) and catl(dissolved in DCM, 0.005 mmol, 0.4 equivalent amount) were added to an o-phthalaldehyde monomer solution (dissolved in DCM, 2 mmol, 100 equivalent amount) sequentially by dry injectors, to initiate polymerization. The solution was rapidly stirred at 40° C. After a predetermined time interval, aliquot samples was taken out and terminated by pre-cooled methanol (0.10 mL) comprising a small amount of Et₃N (5% v/v, in MeOH). The conversion rate of the monomer was measured by ¹ HNMR spectroscopy, and the molecular weight (Mₙ=59.0 kDa, M_{w}/Mₙ=1.25) was measured by size exclusion chromatography (SEC). In order to obtain separated polymer, the solution was subjected to precipitation by using cold methanol. The obtained produce was subjected to centrifugal separation and was dried in vacuum for 24 hours.

### Example 6

Living cationic polymerization of 4-methoxystyrene by supermolecular anion-binding catalysis

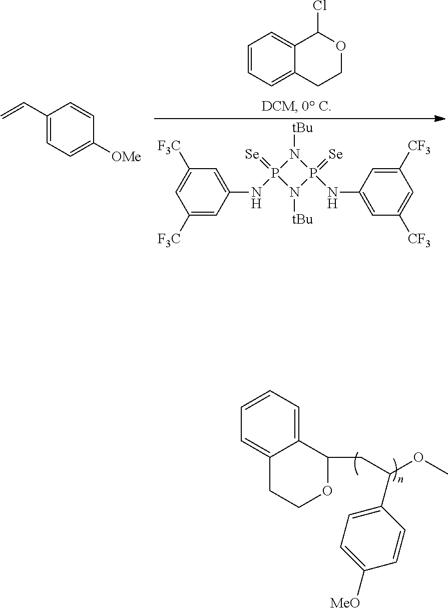

The process of polymerization is as follows. In a schlenk glass tube being baked, the pre-cooled initiator ICCl (dissolved in DCM, 0.02 mmol, 1 equivalent amount) and cat1 (dissolved in DCM, 0.005 mmol, 0.4 equivalent amount) were added to a 4-methoxystyrene monomer solution (dissolved in DCM, 2 mmol, 100 equivalent amount) sequentially by dry injectors, to initiate polymerization. The solution was rapidly stirred at 0° C. After a predetermined time interval, aliquot samples was taken out and terminated by pre-cooled methanol (0.10 mL) comprising a small amount of Et₃N (5% v/v, in MeOH). The conversion rate of the monomer was measured by ¹H NMR spectroscopy, and the molecular weight (Mₙ=13.0 kDa, M_{w}/Mₙ=1.12) was measured by size exclusion chromatography (SEC). In order to obtain separated polymer, the solution was subjected to precipitation by using cold methanol. The obtained produce was subjected to centrifugal separation and was dried in vacuum for 24 hours.

Obviously, the above-mentioned Examples are only examples made for clear description, but are not limitation to the embodiments. For those skilled in the art, other different forms of changes or modifications may be made on the basis of the above description. Listing all embodiments herein is not needed and cannot be done. The obvious changes or modifications extended from the specification are still in the protection scope of the present application.

What is claimed is:

1. A method of performing living cationic polymerization of monomers by supermolecular anion-binding catalysis, comprising the following steps of:
in the presence of a cationic initiator and a hydrogen-bond donor, polymerizing one or more electron-rich ethylenic monomers or other monomers capable of being polymerized by cationic polymerization with a controllable activity to form a homopolymer or a copolymer;
the cationic initiator is an initiator capable of generating a cationic active species by an effect of the hydrogen-bond donor;
the hydrogen-bond donor is a hydrogen-bond donor capable of extracting and binding a counter anion from the cationic initiator or a chain end of a dormant polymer to generate the cationic active species by a supermolecular anion-binding interaction, to realize instant reversible conversion between a dormant species and the cationic active species, and to facilitate a polymerization reaction between the cationic active species and a monomer capable of being polymerized by cationic polymerization.

2. The method according to claim 1, wherein the cationic initiator is a Bronsted acid or an adduct;
the Bronsted acid has a general structural formula of H—X;
wherein X is selected from Cl, Br, I, ClO₄, BrO₄, IO₄, CN, N₃, (C₆F₅)₄B, SCN, NO₂, PF₆, BF₄, SbF₆, R¹⁹COO, R²⁰SO₃, OP(═O)(OR²¹)₂, SC(═S)NR²², OR²³, SR²⁴ or N(SO₂R²⁵)₂;
R¹⁹, R²⁰, R²¹, R²², R²³, R²⁴ and R²⁵ are independently selected from hydrogen, a halogen atom, CN, SCN, NO₂, C₆F₅, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group or a C₅₋₃₀ heteroaryl group;
the adduct is one or more selected from the following general structural formulas: 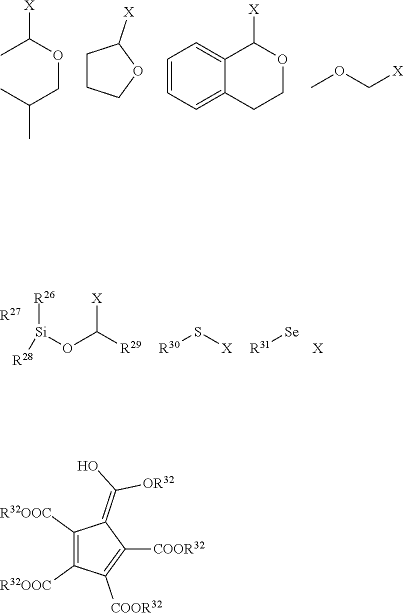
wherein X has a definition as above, R²⁶, R²⁷, R²⁸, R²⁹, R³⁰, R³¹and R³² are independently selected from hydrogen, a C₁₋₃₀ alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, or a C₅₋₃₀ heteroaryl group.

3. The method according to claim 1, wherein the Bronsted acid is one selected from the following structures: 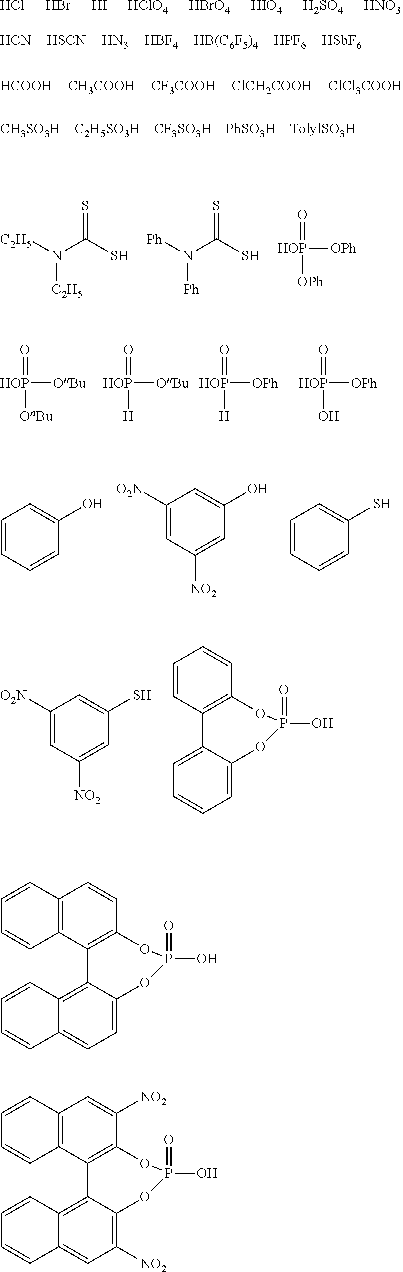 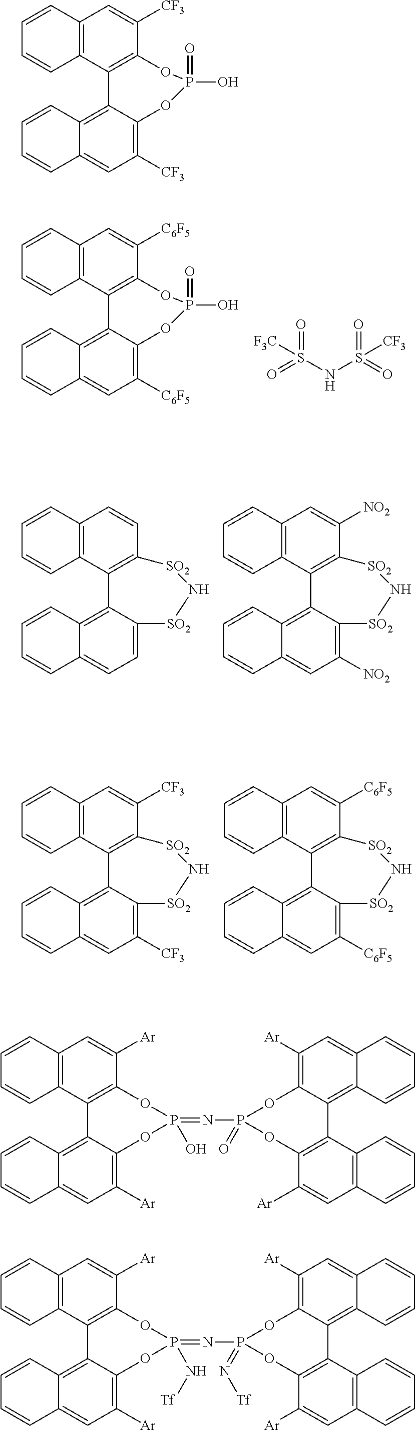
wherein Ph represents phenyl; ⁿBu represents n-butyl; tolyl represents tolyl; Ar represents aryl; Tf represents trifluoromethanesulfonyl;
the adduct is one or more selected from the following structures:

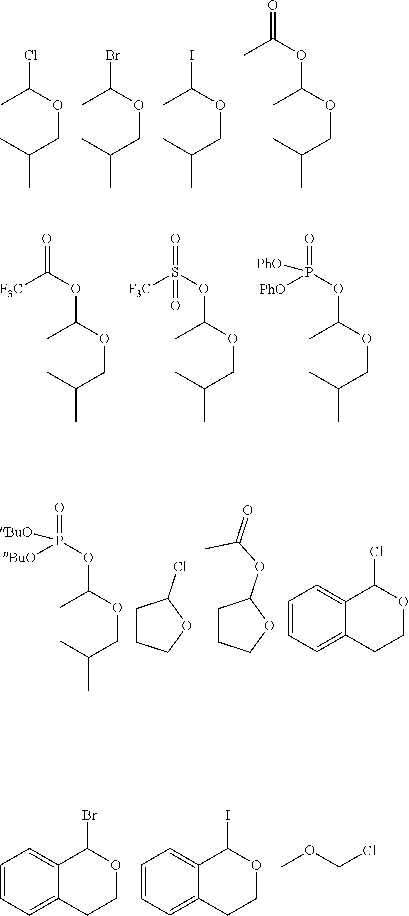

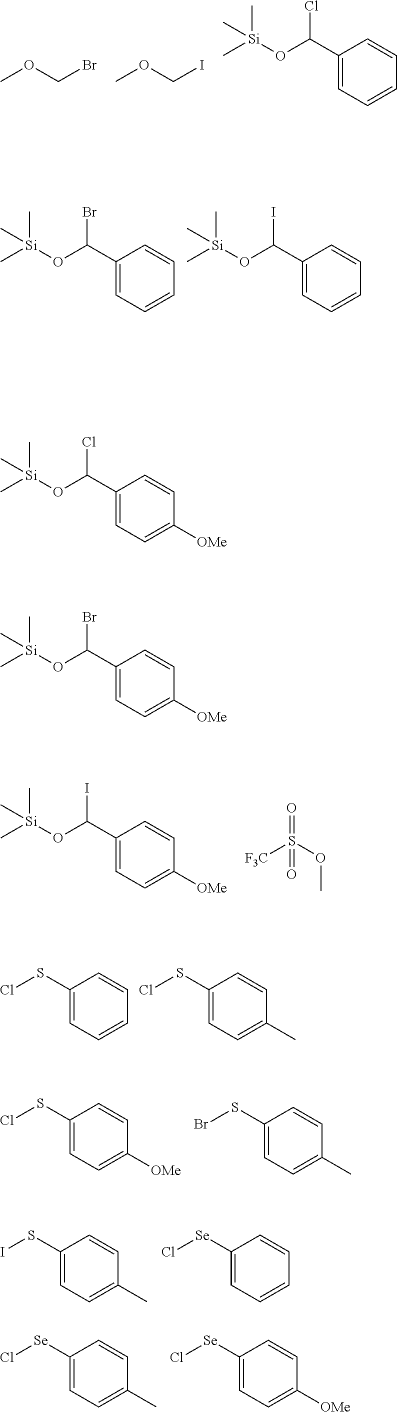

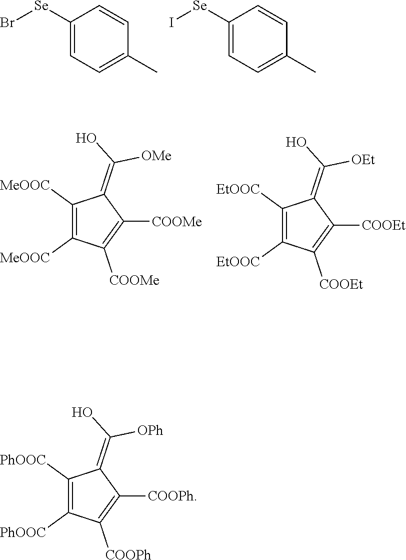

4. The method according to claim 1, wherein the hydrogen-bond donor is one or more selected from the following general structural formulas: 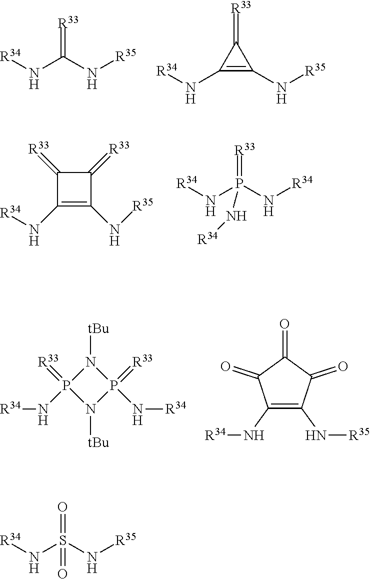
wherein R³³ is defined as one of O, S and Se, R³⁴ and R³⁵ are independently selected from one in hydrogen, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group and a C₅₋₃₀ heteroaryl group.

5. The method according to claim 4, wherein the hydrogen-bond donor is one or more selected from the following structures: 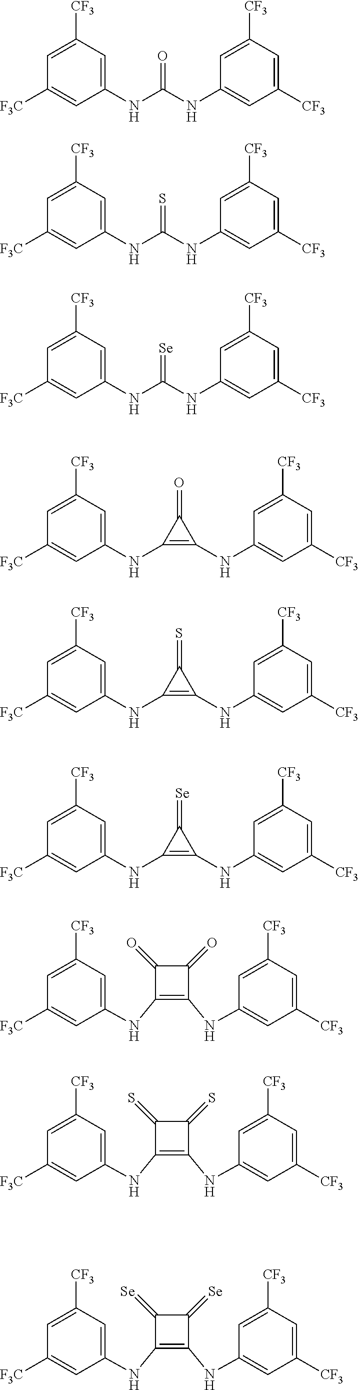 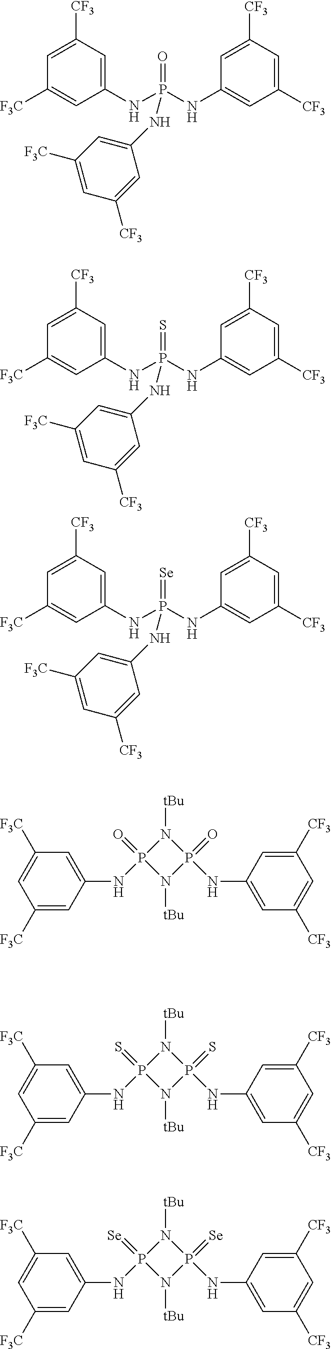 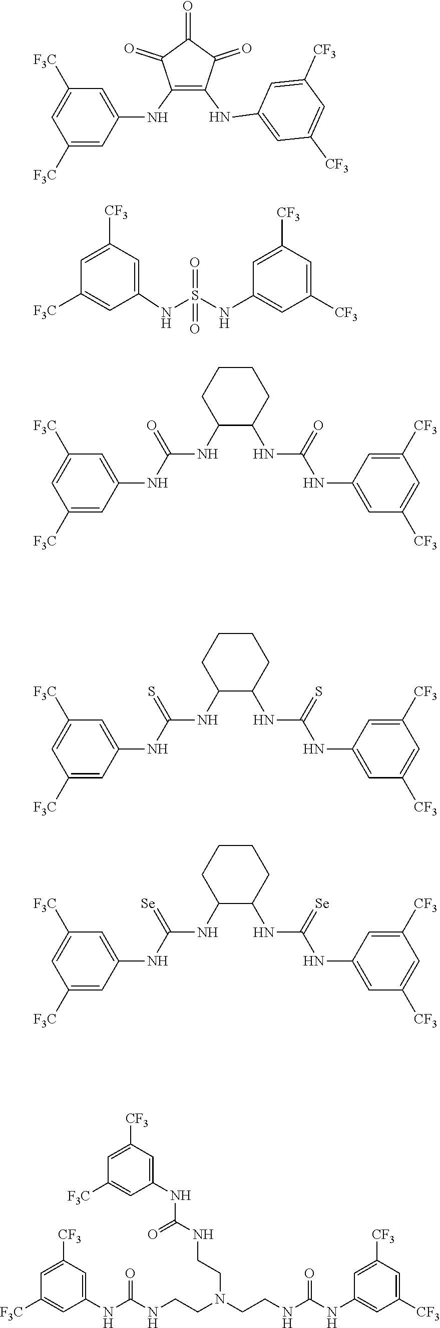 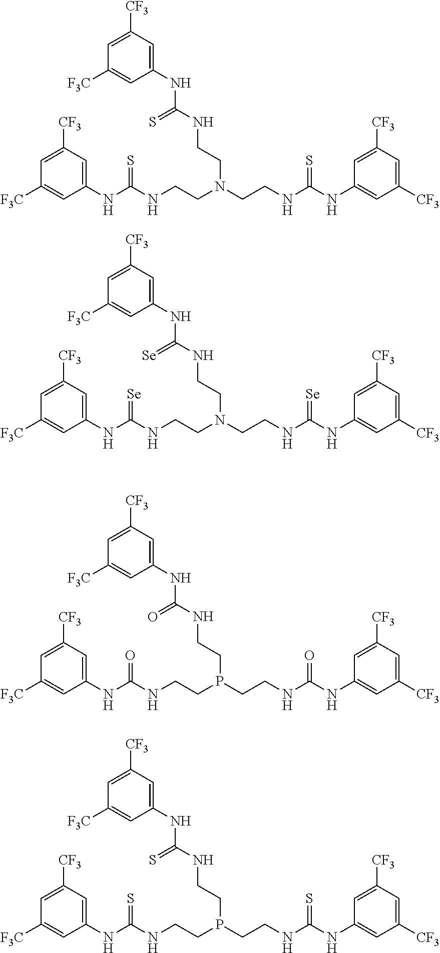 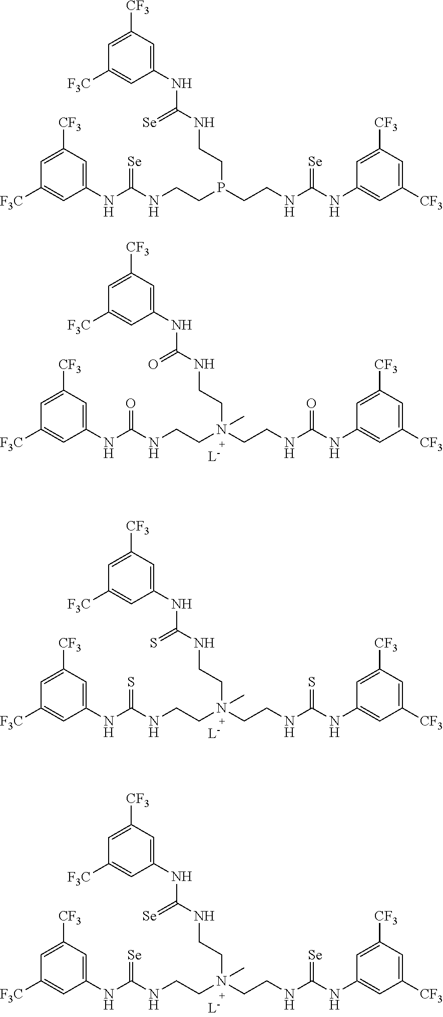 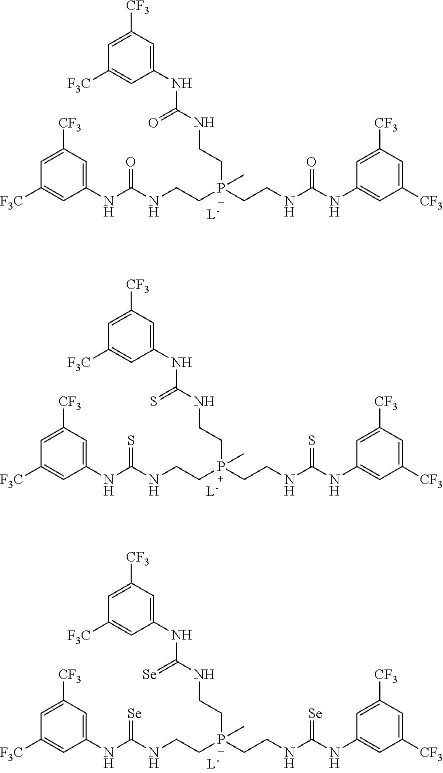
wherein is one selected from Cl⁻, Br⁻, I⁻, N₃⁻, BF₄⁻, PF₆⁻, SbF₆⁻, BPh₄⁻, B(C₆F₅)₄⁻ and OTf.

6. The method according to claim 1, wherein the electron-rich ethylenic monomer has a general structural formula as shown below: 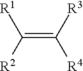
wherein R¹ and R² are independently selected from hydrogen or a C₁₋₆ alkyl group, while at least one of R¹ and R² is a hydrogen atom; R³ and R⁴ are independently selected from hydrogen, a C₁₋₃₀ alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, a C₅₋₃₀ heteroaryl group, OR⁵ or NR⁶R⁷;
R⁵ is one selected from C₂H₄OCH₃, C₂H₄C₁, a C₁₋₆ alkyl group and a C₃₋₆ alicyclic hydrocarbon group; R⁶ and R⁷ are both a C₆₋₃₀ aryl group.

7. The method according to claim 1, wherein the electron-rich ethylenic monomer is one or more selected from the following structures: 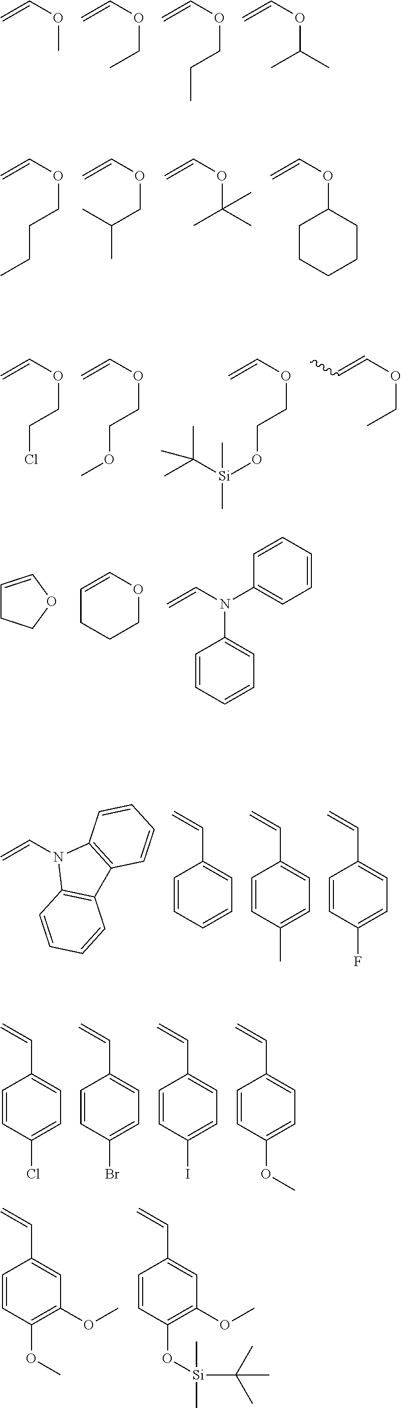 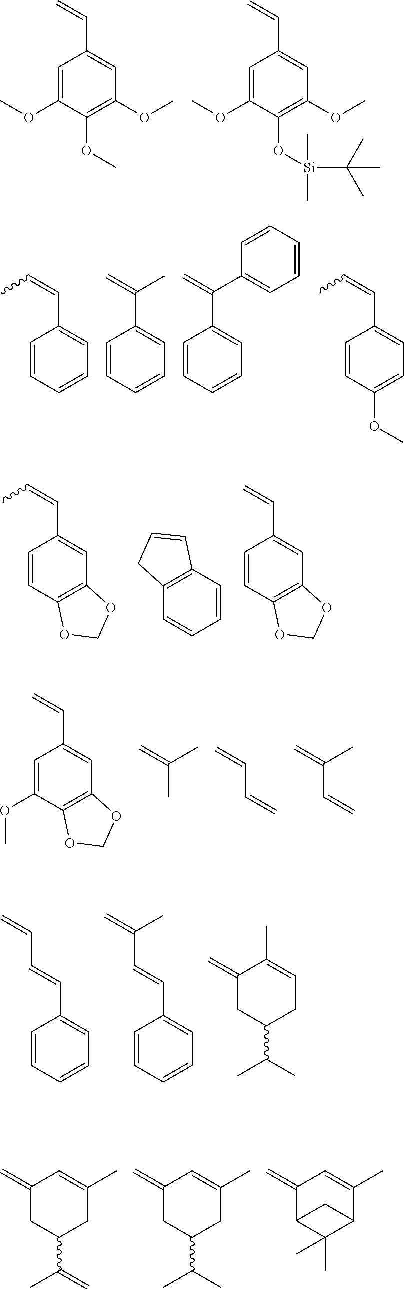 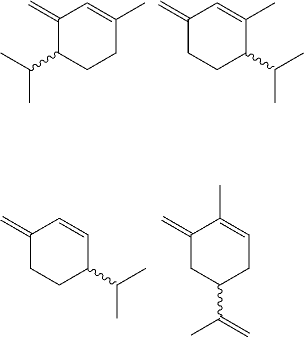
in the above structures, the mark [symbol] represents that a substitute group has a chiral spatial configuration of an R configuration or an S configuration, or that a double bond has a spatial configuration of Z configuration or E configuration.

8. The method according to claim 1, wherein the other monomer capable of being polymerized by cationic polymerization is one or more selected from the following general structural formulas: 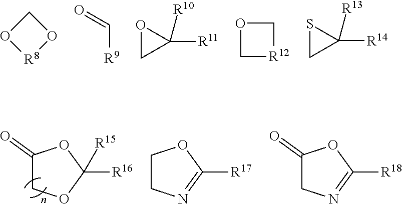
wherein R⁸, R⁹, R¹⁰, R¹¹, R¹², R¹³, R¹⁴, R⁵, R¹⁶, R¹⁷, R¹⁸ are independently selected from hydrogen, a halogen atom, C₆F₅, a C₁₋₃₀ perfluoroalkyl group, a C₁₋₃₀ straight chain or branched chain aliphatic alkyl group, a C₁₋₃₀ substituted or unsubstituted alicyclic hydrocarbon group, a C₆₋₃₀ aryl group, a C₂₋₃₀ alkenyl group, a C₂₋₃₀ alkynyl group, a C₃₋₃₀ heterocyclic group, or a C₅₋₃₀ heteroaryl group; n is a positive integer of 1 to 5.

9. The method according to claim 8, wherein the other monomer capable of being polymerized by cationic polymerization is one or more selected from the following structures:

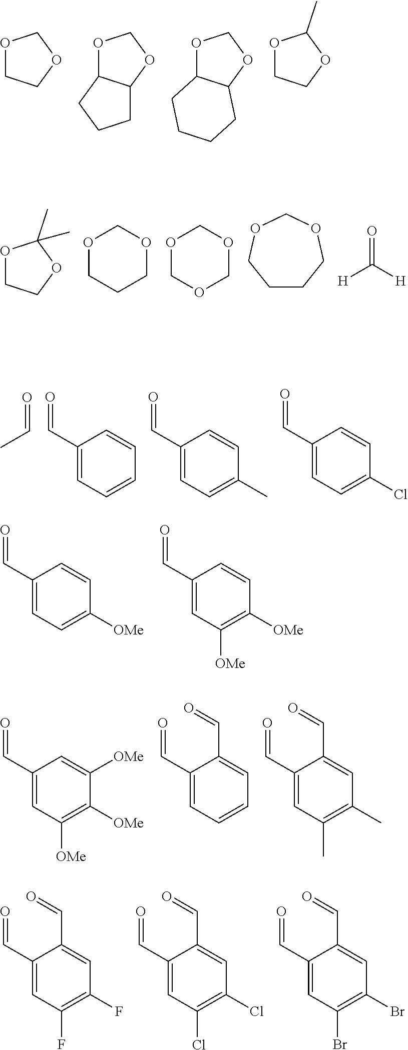

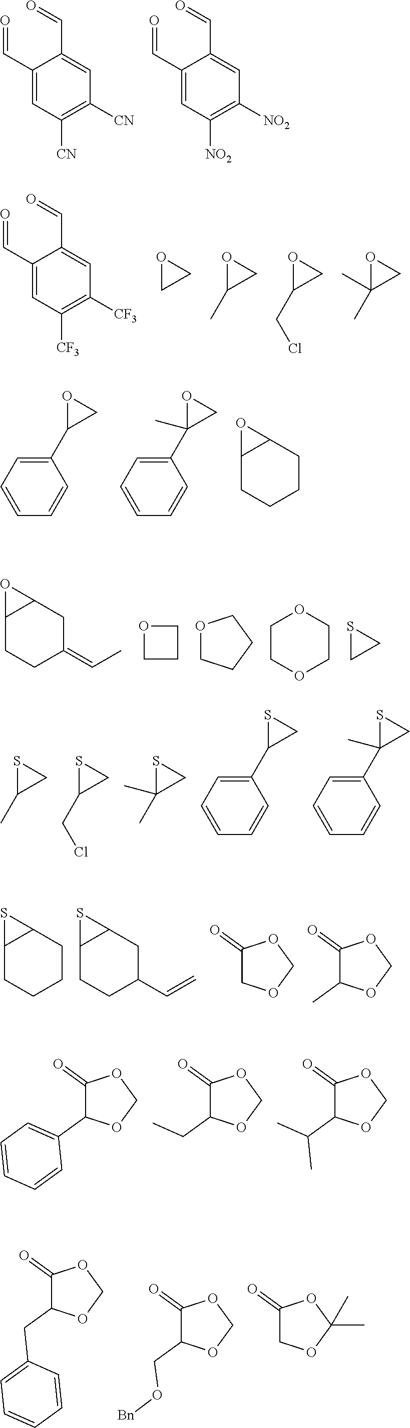

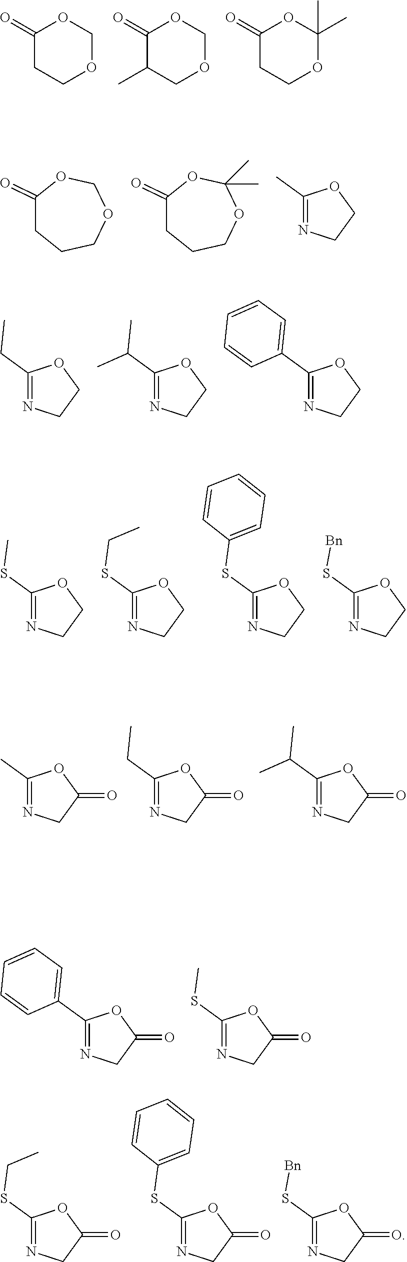

10. The method according to claim 1, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

11. The method according to claim 2, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

12. The method according to claim 3, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

13. The method according to claim 4, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

14. The method according to claim 5, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

15. The method according to claim 6, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

16. The method according to claim 7, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

17. The method according to claim 8, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.

18. The method according to claim 9, wherein the cationic initiator has a concentration of 10⁻⁵ mol/L to 1 mol/L; the cationic initiator has a molar ratio of 10⁻⁴:1 to 10⁻¹:1 with respect to the monomer; and the hydrogen-bond donor has a molar ratio of 0.0001:1 to 10:1 with respect to the cationic initiator.
